(19) United States
(12) Patent Application Publication
(10) Pub. No.: US 2012/0131287 A1
(43) Pub. Date: May 24, 2012

(54) STORAGE CONTROL APPARATUS AND LOGICAL VOLUME SIZE SETTING METHOD

(76) Inventors: Tadato Nishina, Odawara (JP); Kohei Tatara, Yokohama (JP); Masayuki Yamamoto, Sagamihara (JP); Yoshiaki Eguchi, Yokohama (JP); Shunji Kawamura, Yokohama (JP); Akira Deguchi, Yokohama (JP)

(21) Appl. No.: 13/054,044

(22) PCT Filed: Nov. 19, 2010
(86) PCT No.: PCT/JP2010/006787

§ 371 Date: Jan. 13, 2011

(51) Int. Cl. G06F 12/00

(52) U.S. Cl. 711/154; 711/E12.001

(57) ABSTRACT

The present invention efficiently changes a volume size while maintaining a copy pair as-is. A PVOL and a SVOL #1 are in a pair state and are synchronized. The PVOL and a SVOL #2 are in a restore state. Upon instruction of expansion of the size of the PVOL, the size of a copy-destination SVOL #1 is first expanded, the size of the PVOL is then expanded, and the size of the SVOL #2 is lastly expanded. In the case of a PSUS state, only the size of the PVOL is expanded, and the size of the SVOL is left as-is.

### TECHNICAL FIELD

The present invention relates to a storage control apparatus and a method for setting the size of a logical volume.

### BACKGROUND ART

A storage control apparatus comprises a copy function for copying data of one logical volume to another logical volume. By using this copy function, a user is able to create a backup of data to be used in work.

Technology that makes it possible to maintain a copy pair as-is and either expand or reduce the size of the copy-source volume, the size of the copy-destination volume, and the size of the difference bitmap is known (Patent Literature 1).

Furthermore, technology for providing a virtual logical volume to a host computer and allocating a real storage area to this virtual logical volume when the host computer writes data to this virtual logical volume has also become known in recent years (Patent Literature 2).

### CITATION LIST

### Patent Literature

### [PTL 1]

Japanese Patent Application Laid-open No. 2009-93315

### [PTL 2]

Japanese Patent Application Laid-open No. 2003-015915

### SUMMARY OF INVENTION

### Technical Problem

In the prior art, it is possible to change the size of each logical volume while maintaining the copy pair as-is. However, changing the size of the copy-source volume and the copy-destination volume in accordance with the status of the copy pair at substantially the same time can give rise to either waste or problems as follows.

In a case where the copy pair is in the suspend state (may also be called the PSUS state hereinafter), the copy source volume and the copy-destination volume are separated and each stores data. A pair operation for making the copy-source volume data identical to the copy-destination volume data is not carried out right away even when the size of each logical volume in the PSUS state is expanded at substantially the same time.

Most often the volume size expansion time is not identical to the pair operation time. Therefore, a new storage area that has been added to the copy-destination volume is not used at all until the copy pair operation for making the storage contents of the copy-source volume and the copy-destination volume identical has begun, and the newly added area is of no use until the pair operation gets started.

The storage control apparatus provides multiple logical volumes to multiple host computers, and, in addition, the physical storage resources (either hard disks or flash memory devices) of the storage control apparatus are limited. Therefore, the limited physical storage resources should be used effectively. However, in the prior art, even when a copy pair is in the PSUS state, the size of the copy-destination volume is expanded together with the expansion of the size of the copy-source volume, making it impossible to effectively use the storage resources of the storage control apparatus.

In addition, in a PSUS state copy pair, when the size of the copy-source volume is reduced together with the size of the copy-destination volume, for example, the area to be used for a backup or other such purpose can also be reduced. Therefore, in the prior art, reliability when changing the size setting drops depending on the copy pair status.

However, in recent years, what is called Thin Provisioning technology, which is designed to provide a virtual logical volume to a host computer and to allocate to the host computer only the real storage area that was actually used, has also become known.

A case in which either one of the logical volumes forming a copy pair is a virtual logical volume created using Thin Provisioning technology is conceivable. In accordance with this, management information for managing the corresponding relationship between the virtual logical volume and the real storage area inside a pool must also be changed in accordance with the size changes of the copy-source volume and the copy-destination volume.

In the prior art, only the size change of an ordinary logical volume (a real volume) is considered; differences in the type of logical volume are not taken into consideration.

In addition, in a case where the sizes of the logical volumes forming a copy pair are changed inside the storage control apparatus, it is conceivable that the volume size recognized by the host computer may not match the actual volume size. Therefore, the time at which the volume size is changed inside the storage control apparatus must be adjusted to the time that the host computer recognizes the volume size. The prior art does not include an aspect like this.

The present invention was made with the above-mentioned problems in mind, and one object thereof is to provide a storage control apparatus and a logical volume size setting method that are able to determine a logical volume, whose size is to be changed based on the status of a copy pair, and a time for changing the size. Other objects of the present invention should become clear from the following description of the embodiment.

### Solution to Problem

To solve for the above-mentioned problem, a storage control apparatus related to the present invention inputs and outputs data based on commands from a host computer, and comprises multiple logical volumes used by the host computer and a controller for controlling the respective logical volumes. The controller comprises a microprocessor and a memory for storing a prescribed computer program that is executed by the microprocessor.

By reading from the memory and executing a prescribed computer program, upon receiving a size change instruction with respect to a prescribed logical volume selected from among the multiple logical volumes, the microprocessor decides on one or more logical volumes including at least the prescribed logical volume from among the multiple logical volumes, as a change-target volume to be a size change target, decides on a prescribed time for changing the size of the decided change-target logical volume, and changes the size of the decided change-target logical volume to a prescribed value specified in the change instruction at the decided prescribed time.

The microprocessor, in a case where the statuses of the copy pair are pair and resynch, decides on a primary volume and a secondary volume related to the copy pair as change-target logical volumes, and in a case where the copy pair status is suspend, decides on only the primary volume related to the copy pair as the change-target logical volume, and in a case where the copy pair status is restore, may decide on the primary volume and the secondary volume related to the copy pair as the change-target logical volumes.

The microprocessor, in a case where multiple change-target logical volumes have been decided, may decide a prescribed time by taking into account whether the change instruction denotes a size expansion or a size reduction, and the direction in which data is sent.

The microprocessor may synchronize the time at which the host computer re-recognizes the size of the change-target logical volume with the prescribed time for changing the size.

The present invention can also be discerned as a method for setting the size of the logical volume. In addition, at least one part of the present invention may be configured as a computer program. Furthermore, multiple characteristic features of the present invention described in the embodiments can also be freely combined.

### BRIEF DESCRIPTION OF DRAWINGS

FIG. 1 is an overall diagram of a computer system comprising a storage apparatus.

FIG. 2 is an example of another configuration of the computer system.

FIG. 3 shows the configuration of a server.

FIG. 4 shows the configuration of a storage apparatus.

FIG. 5 shows the configuration of a management server.

FIG. 6 shows information for managing a logical volume.

FIG. 7 shows information for managing a copy pair.

FIG. 8 shows information for managing a corresponding relationship between the server and the logical volume.

FIG. 9 schematically shows how to expand the size of each logical volume in a case where multiple secondary volumes are associated with a single primary volume.

FIG. 10 is a flowchart showing the process for expanding the volume size.

FIG. 11 is a flowchart showing a first expansion process for expanding a secondary volume.

FIG. 12 is a flowchart showing a second expansion process for expanding another secondary volume.

FIG. 13 is a flowchart showing an ordinary expansion process for expanding the size of a volume.

FIG. 14 is a flowchart showing a process for restoring an expanded volume to its original size.

FIG. 15 schematically shows how to reduce the size of each logical volume in a case where multiple secondary volumes are associated with a single primary volume.

FIG. 16 is a flowchart showing a volume size reduction reservation process, which is implemented prior to reducing the volume size.

FIG. 17 is a flowchart showing a process for restoring the reduction reservation process to its original state.

FIG. 18 is a flowchart showing a process for reducing the volume size.

FIG. 19 is a flowchart showing a first reduction process for reducing a secondary volume.

FIG. 20 is a flowchart showing a second reduction process for reducing another secondary volume.

FIG. 21 is a flowchart showing an ordinary reduction process for reducing volume size.

FIG. 22 is a flowchart showing a process for making the volume size identical to prior to the execution of a restore.

FIG. 23 is a flowchart showing a process for making the volume size identical to prior to the execution of a resynch.

FIG. 24 is the overall sequence when expanding the size of a volume.

FIG. 25 is the overall sequence when reducing the size of a volume.

FIG. 26 is a diagram of the configuration of a storage apparatus related to a second embodiment.

FIG. 27 schematically shows the volume configuration of the storage apparatus.

FIG. 28 shows information for managing a virtual volume.

FIG. 29 is a flowchart showing a process for expanding the size of a virtual volume.

FIG. 30 is a flowchart showing a process for reducing the size of a virtual volume.

FIG. 31 is a flowchart showing a process for restoring an expanded volume to its original size.

FIG. 32 shows the configuration of a storage apparatus related to a third embodiment.

FIG. 33 schematically shows the volume configuration of the storage apparatus.

FIG. 34 shows information for managing a snapshot.

FIG. 35 is a flowchart showing a process for expanding the size of a snapshot volume.

FIG. 36 is a flowchart showing a process for reducing the size of an ordinary logical volume.

FIG. 37 is a flowchart showing a process for reducing the size of a snapshot volume.

FIG. 38 is a flowchart showing a process for restoring an expanded volume to its original size.

FIG. 39 is a diagram of the configuration of a storage apparatus related to a fourth embodiment.

### DESCRIPTION OF EMBODIMENTS

The embodiments of the present invention will be explained hereinbelow based on the drawings. In this embodiment, as will be explained hereinbelow, there is disclosed at least a configuration such that in a computer system, which comprises at least one host computer 20A, 20B, at least one storage control apparatus 10A, 10B, which is used by the host computer, and a management apparatus 30 for managing the host computer and the storage control apparatus, the storage control apparatus 10A, 10B comprises a controller 11A, 11B, and a logical volume 12A, 12B, the controller (1) upon receiving from the management apparatus 30 a size change instruction with respect to a prescribed logical volume selected from among multiple logical volumes, (2) decides on one or more logical volumes, which include at least the prescribed logical volume from among the multiple logical volumes, as a change-target volume, which is a size change target, (3) decides a prescribed time for changing the size of the decided change-target logical volume, and (4) at the decided prescribed time, changes the size of the decided change-target logical volume to a prescribed value specified in the change instruction.” However, the present invention is not limited to the above-described configuration.

### Embodiment 1

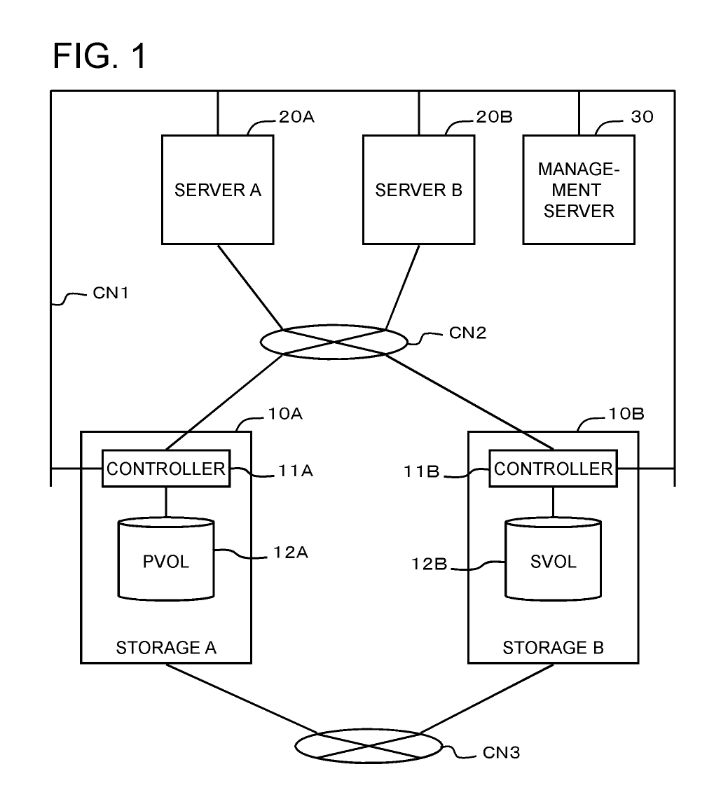

FIG. 1 shows an example of a computer system. The computer system, for example, comprises multiple storage apparatuses 10A, 10B, multiple servers 20A, 20B, and at least one management server 30.

The management server 30 is connected to each storage apparatus 10A, 10B and each server 20A, 20B via a management communication network CN1. Each server 20A, 20B is connected to each storage apparatus 10A, 10B via a data input/output communication network CN2. In addition, the storage apparatus 10A and the storage apparatus 10B are connected via a remote copy communication network CN3.

The management communication network CN1, for example, is configured as a LAN (Local Area Network). The data input/output communication network CN2 and the remote copy communication network CN3, for example, are configured like either a FC-SAN (Fibre Channel-Storage Area Network) or a IP-SAN (Internet Protocol SAN). Furthermore, CN1, CN2 and CN3 may be configured as a single communication network. Also, CN2 and CN3 may be configured as a single network, and CN1 may be configured as a separate communication network. In the drawing, data input/output is expressed as I/O (Input/Output).

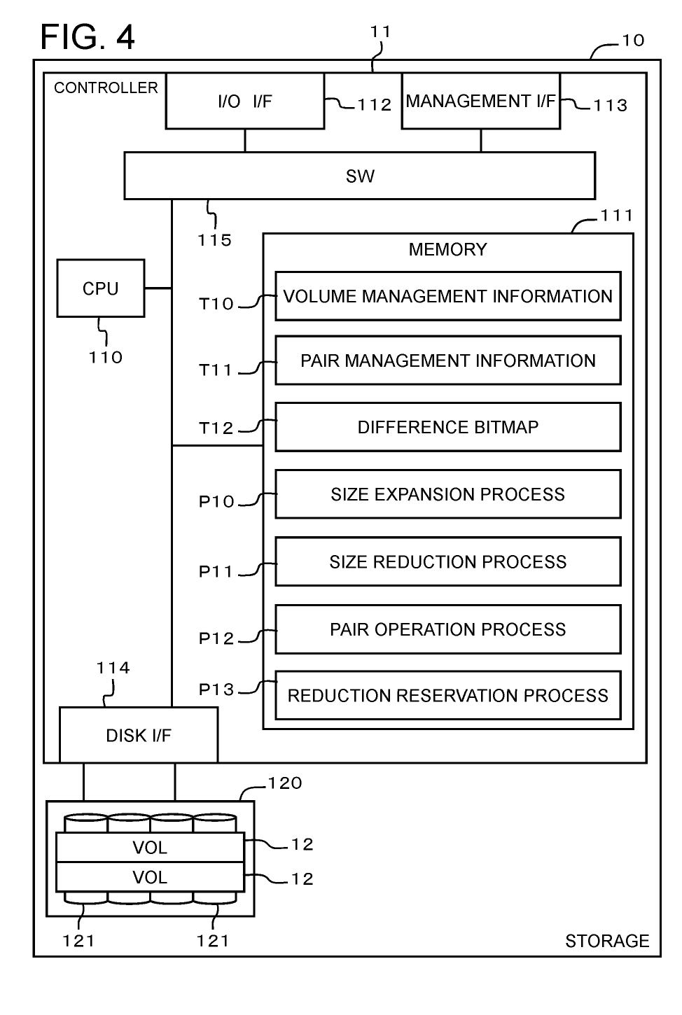

The storage apparatuses 10A and 10B, which serve as the “storage control apparatus”, store data that is used by the servers 20A, 20B. The storage apparatuses 10A, 10B comprise controllers 11a, 11B, and logical volumes 12A, 12B. The configuration of the storage apparatuses 10A, 10B is described in FIG. 4. In the following explanation, the logical volume may be called a volume.

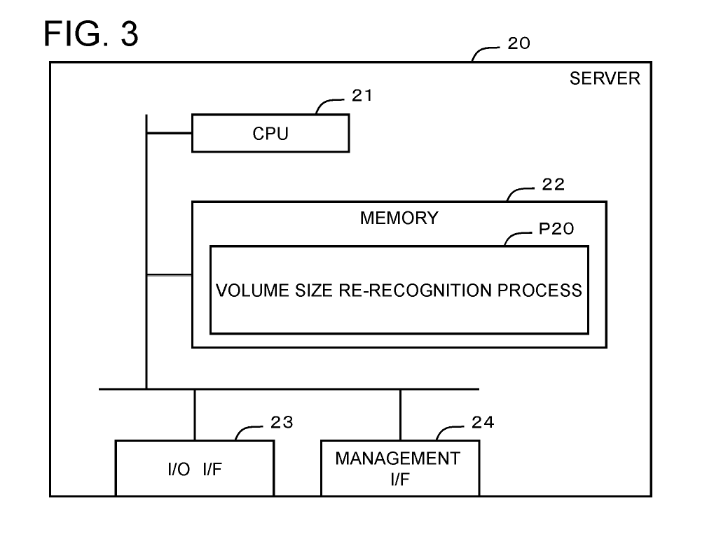

The servers 20A and 20B, which serve as the “host computer”, for example, execute various types of business processes, such as customer management, image delivery, and electronic-mail management. The servers 20A, 20B access the logical volumes 12A, 12B of the storage apparatuses 10A, 10B to read and write data for the business processes. The servers 10A, 10B, for example, can be configured as server computers, mainframe computers, personal computers, engineering workstations, personal digital assistants or other such computers. The configuration of the servers 10A, 10B is described in FIG. 3.

The management server 30 is a computer for managing the computer system. The management server 30 manages the respective configurations and states of the computer system. The management server 30 issues a command for a pair operation to the storage apparatuses 10A, 10B.

The management server 30, like the servers 20A, 20B, can be configured from various computers. The management server 30 may be configured from multiple computers. For example, the configuration may be such that a management terminal is provided for a user (a system administrator) to perform operations, and the management terminal is connected to the management server 30. The user can use the management terminal to issue instructions to the management server 30 and to display information acquired from the management server 30. The management terminal can be configured as either a personal computer or a personal digital assistant (to include a mobile telephone).

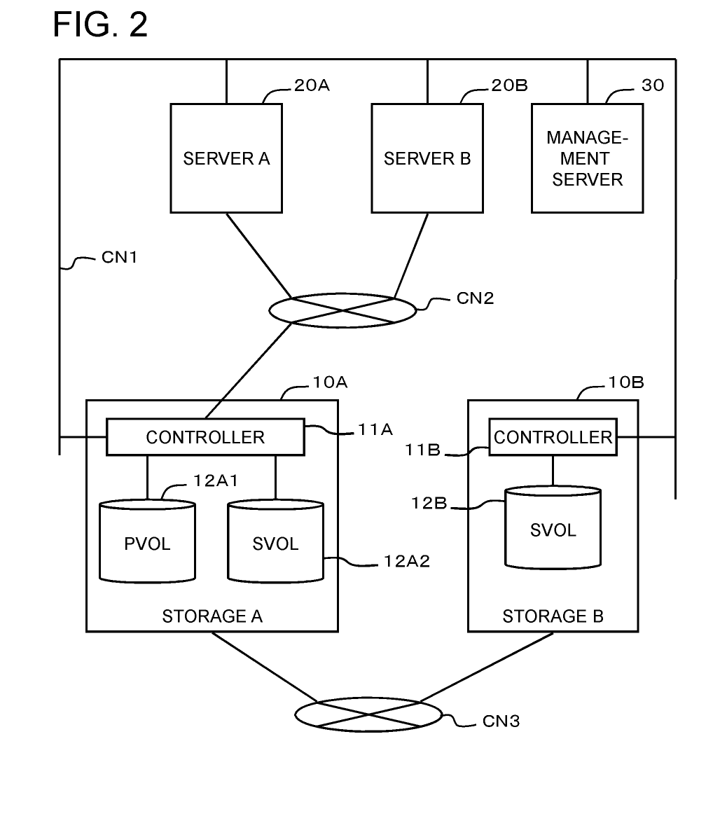

FIG. 2 shows another example of a computer system. In the example of FIG. 1, a primary volume 12A and a secondary volume 12B are each disposed in separate storage apparatuses 10A, 10B.

By contrast, in the example of FIG. 2, multiple secondary volumes 12A2, 12B are associated with a primary volume 12A1. In addition, one of the secondary volumes 12A2 of the multiple secondary volumes is disposed in the same storage apparatus 10A as the primary volume 12A1. The other secondary volume 12B is disposed in a different storage apparatus 10B from that of the primary volume 12A1.

A copy pair may be formed using multiple logical volumes inside the same storage apparatus 10A like this. Using what is called a local copy technique, data can be transferred between the primary volume 12A1 and the secondary volume 12A2 inside the same storage apparatus 10A.

Or a copy pair may be formed using logical volumes that are each inside a different storage apparatus 10A, 10B. A remote copy technique, as it is called, is used between the primary volume 12A1 and the secondary volume 12B that reside in mutually different storage apparatuses 10A, 10B.

In addition, as shown in FIG. 2, the configuration may be such that multiple secondary volumes 12A2, 12B are associated with a single primary volume 12A1, and one of these secondary volumes 12A2 is disposed in the same storage apparatus 10A as the primary volume 12A1, and the other secondary volume 12B is disposed in the other storage apparatus 10B.

The configuration may also be such that three or more secondary volumes are associated with one primary volume.

FIG. 3 shows the configuration of a server 20. When no particular distinction is made between the two, the servers 20A and 20B will be called the server 20. Similarly, when no particular distinction is made, the storage apparatuses 10A and 10B will be called the storage apparatus 10, the controllers 11A and 11B will be called the controller 11, and the logical volumes 12A and 12B will be called the logical volume 12.

The server 20, for example, comprises a microprocessor (CPU: Central Processing Unit) 21, a memory 22, an I/O interface 23, and a management interface 24, and these components 21 through 24 are interconnected via an internal bus. The interfaces are abbreviated as “I/F” in the drawing.

The microprocessor 21 reads and executes various types of computer programs stored in the memory 22. The memory 22, for example, is configured from either one or multiple storage media like RAM (Random Access Memory), ROM (Read Only Memory), a flash memory device, and a hard disk drive. The I/O interface 23 sends and receives data to and from the server 20 or another storage apparatus 10 by way of the communication networks CN2 and CN3. The management interface 24 communicates with the management server 30 via the communication network CN1.

In addition to an operating system and an application program (neither of which is shown in the drawing), the memory 22 stores a computer program for executing a process P20 for re-recognizing a volume size. The volume size re-recognition process P20 operates in accordance with an instruction from the management server 30, suspends an application program, and acquires from the storage apparatus 10 the size of the logical volume that the application program will use. The volume size re-recognition process P20 resumes the application program after acquiring the volume size (after re-recognizing the volume size).

FIG. 4 shows the configuration of the storage apparatus 10. The storage apparatus 10 comprises a controller 11 and multiple logical volumes 12.

The controller 11 controls the operation of the storage apparatus 10. The controller 11, for example, comprises a microprocessor 110, a memory 111, an I/O interface 112, a management interface 113, a disk interface 114, and a switching circuit 115.

The microprocessor 110 realizes the functions described hereinbelow by reading and executing various types of computer programs P10 through P13 that are stored in the memory 111. The microprocessor 110 is able to refer as needed to various types of management information T10 through T12 when executing the computer programs P10 through P13.

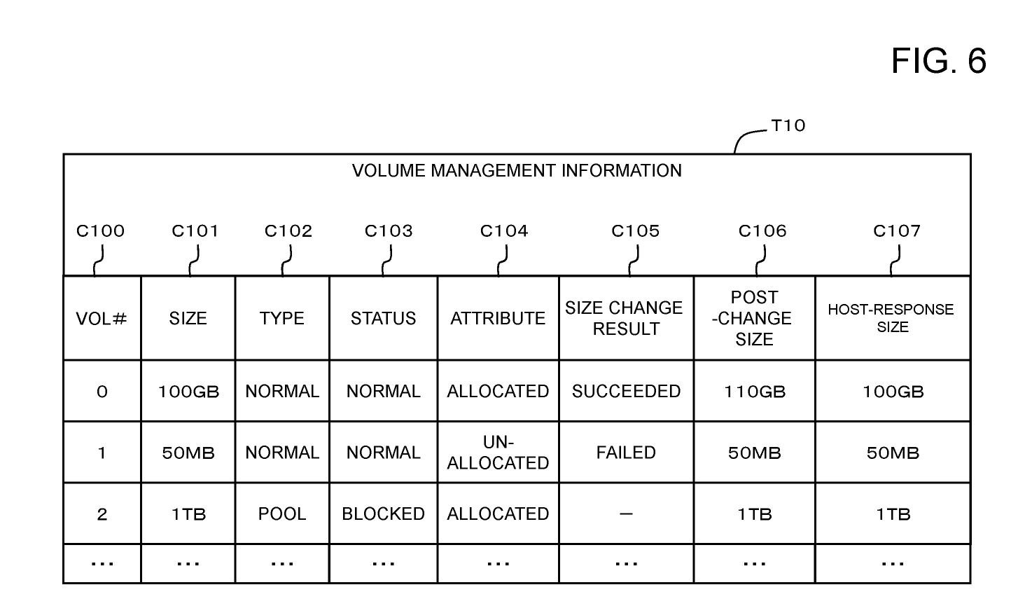

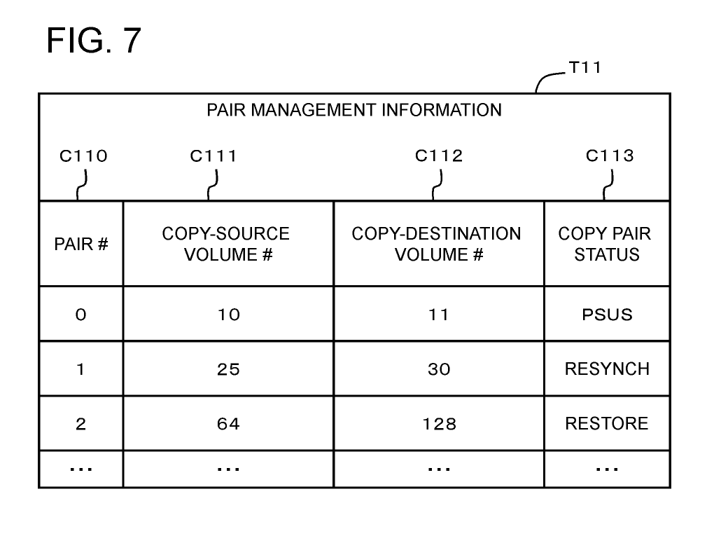

Volume management information T10 is for managing each logical volume of the storage apparatus 10. The volume management information T10 will be explained below using FIG. 6. Pair management information T20 is for managing a copy pair, and will be explained further below using FIG. 7. A difference bitmap T12 is information for managing difference data that occurs between the multiple logical volumes that form a copy pair. The difference bitmap T12 partitions the address space of the logical volume into management area units of a prescribed size, and sets a flag denoting whether or not a difference has occurred for each management area unit.

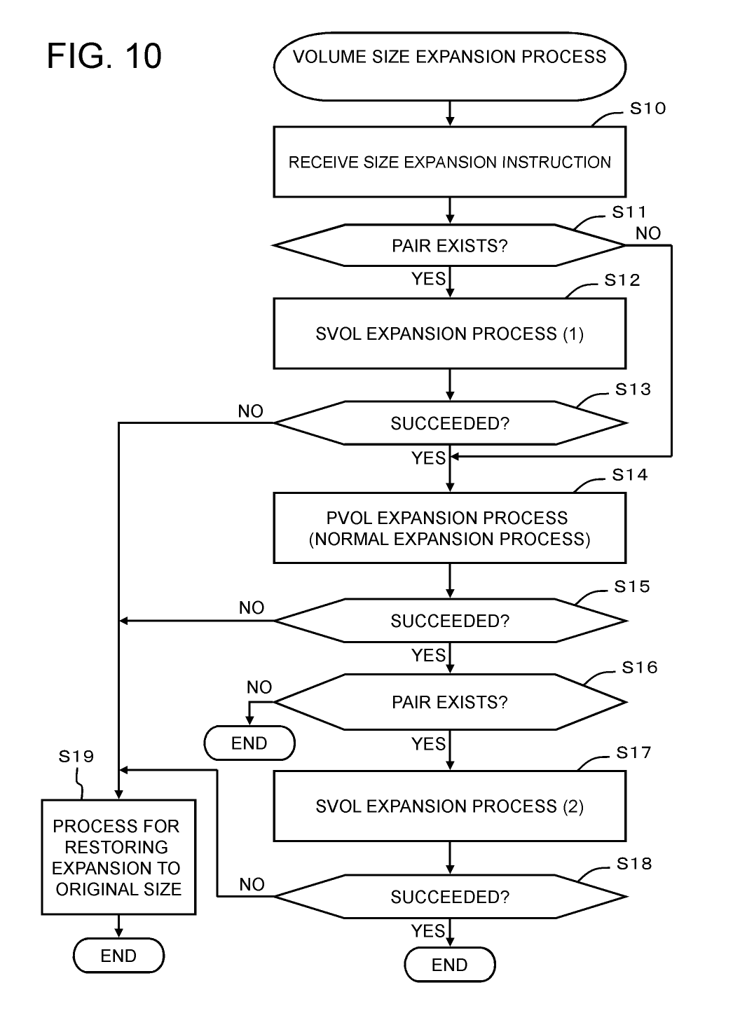

A size expansion process P10 is a computer program for expanding the size of a logical volume. The size expansion process P10 will be explained in detail further below using FIGS. 10 through 14.

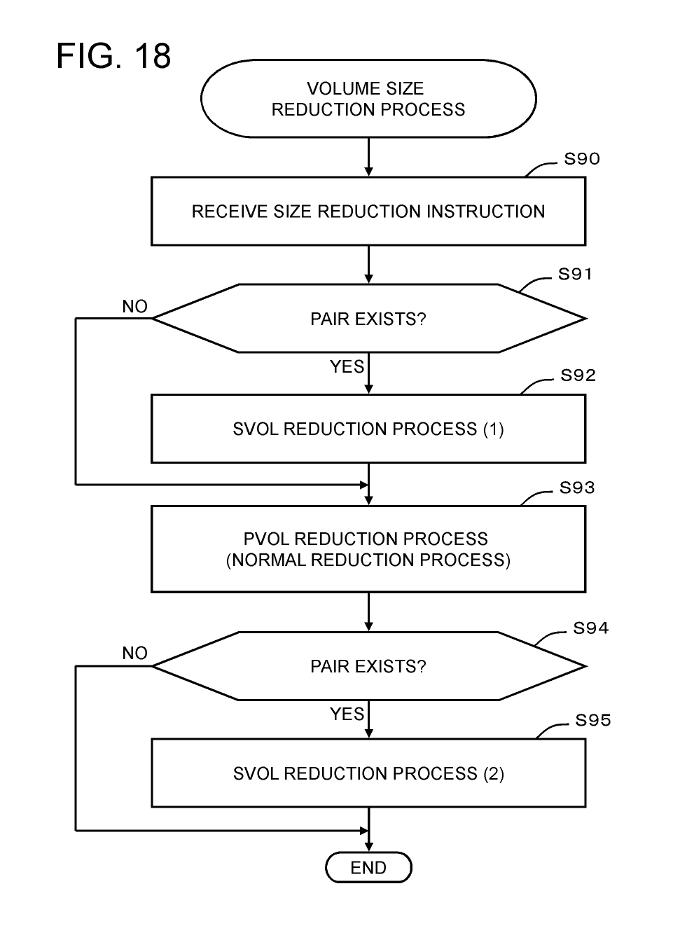

A size reduction process P11 is a computer program for reducing the size of a logical volume. The size reduction process P11 will be explained in detail further below using FIGS. 18 through 21.

A pair operation process P12 is a computer program for operating on the status of a copy pair. The statuses of a copy pair, for example, include a pair state, a PSUS state, a resynch state, and a restore state.

The pair state is a state in which the storage contents of a primary volume and a secondary volume are synchronized. Data that has been written to the primary volume is written to the secondary volume.

A data copy from the primary volume to the secondary volume can be broadly divided into two types: a synchronous copy and an asynchronous copy. In the synchronous copy, the data write to the primary volume and the data write to the secondary volume are carried out simultaneously. In the asynchronous copy, subsequent to writing data to the primary volume, this data is transferred and written to the secondary volume at a separate timing.

The PSUS state is one in which the primary volume and the secondary volume are separated, and each volume manages data independently. In the PSUS state, the data stored in the primary volume and the date stored in the secondary volume are not synchronized. When the server 20 writes data to the primary volume in the PSUS state, difference data is generated between the primary volume and the secondary volume. This difference data is managed by the difference bitmap T12.

The resynch state is one in which difference data between the primary volume and the secondary volume is transferred from the primary volume to the secondary volume, and stored in the secondary volume. When resynch is completed, the copy pair status transitions to the pair state, and the data stored in the primary volume and the data stored in the secondary volume are identical.

The restore state is the state in which the data being stored in the primary volume is made identical to the data stored in the secondary volume by transferring data from the secondary volume to the primary volume. When the restore is complete, the copy pair status transitions to the pair state, and the data stored in the primary volume and the data stored in the secondary volume are identical.

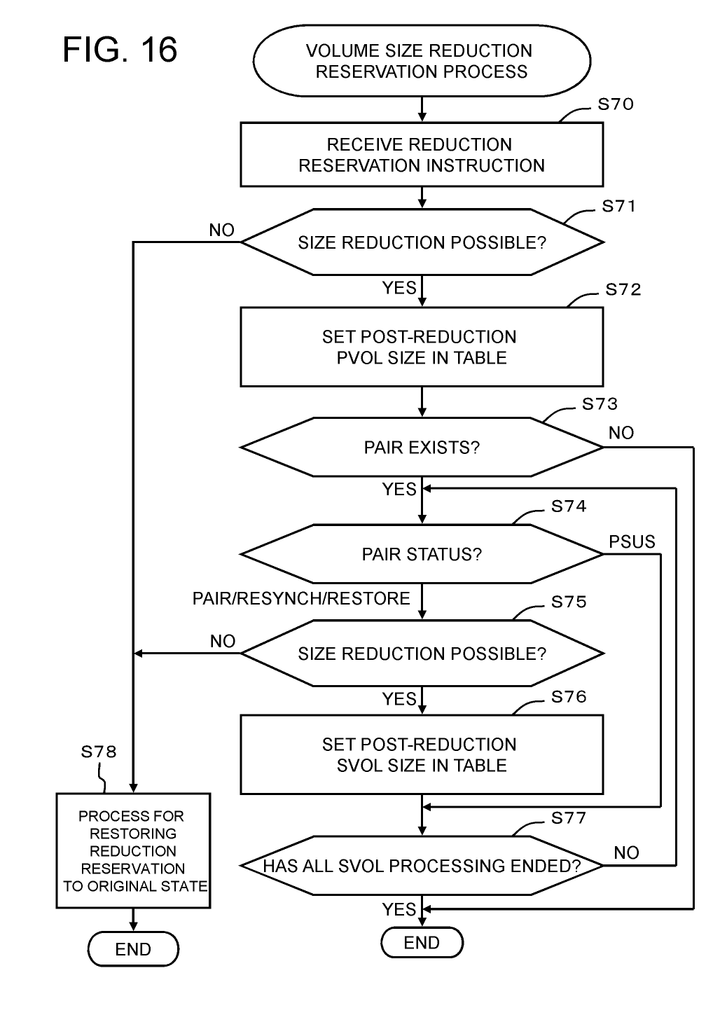

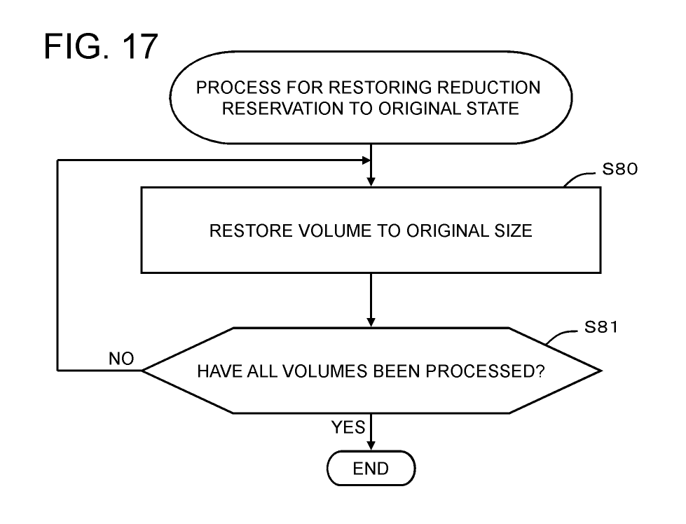

A reduction reservation process P13 is a computer program that is implemented prior to the size reduction process P11 in a case where the size reduction process P11 is to be executed. The reduction process P11 will be described further below using FIGS. 16 and 17.

The I/O interface 112 communicates with either the server 20 or the other storage apparatus 10 via the communication networks CN2 and CN3. The management interface 113 communicates with the management server 30 via the communication network CN1.

The disk interface 114 communicates with multiple storage devices 121. As the storage devices 121, for example, various devices capable of reading and writing data, such as a hard disk device, a semiconductor memory device, an optical disk device, and a magneto-optical disk device can be used.

In a case where a hard disk device is used, for example, a FC (Fibre Channel) disk, a SCSI (Small Computer System Interface) disk, a SATA disk, an ATA (AT Attachment) disk, and a SAS (Serial Attached SCSI) disk can be used. Furthermore, for example, it is also possible to use various storage devices, such as a flash memory, a FeRAM (Ferroelectric Random Access Memory), a MRAM (Magnetoresistive Random Access Memory), an Ovonic Unified Memory, and a RRAM (Resistance RAM). In addition, for example, the configuration may also be a mixture of different types of storage devices, such as a flash memory device and a hard disk drive.

The physical storage areas of the respective multiple storage devices 121 can be collected into a single RAID (Redundant Arrays of Inexpensive Disks) group 120. Either one or multiple logical volumes 12 can be created using the storage area of the RAID group 120.

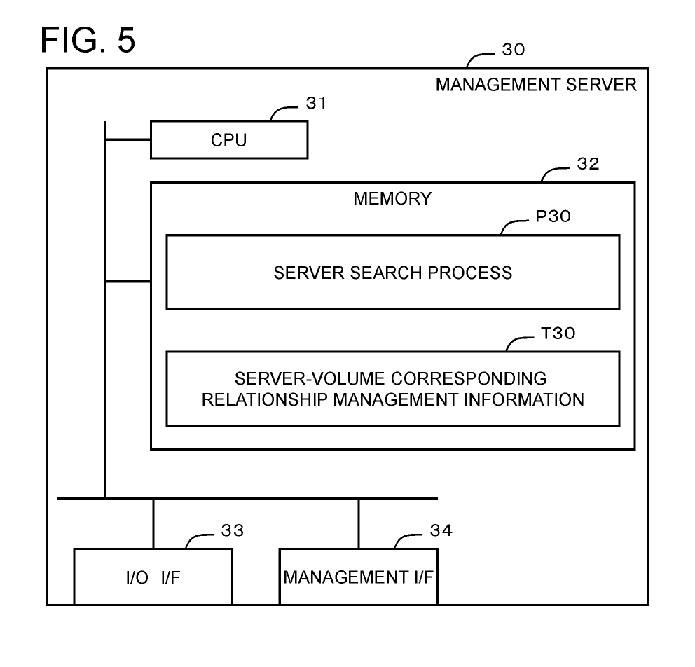

FIG. 5 shows the configuration of the management server 30. The management server 30, for example, comprises a microprocessor 31, a memory 32, an I/O interface 33, and a management interface 34.

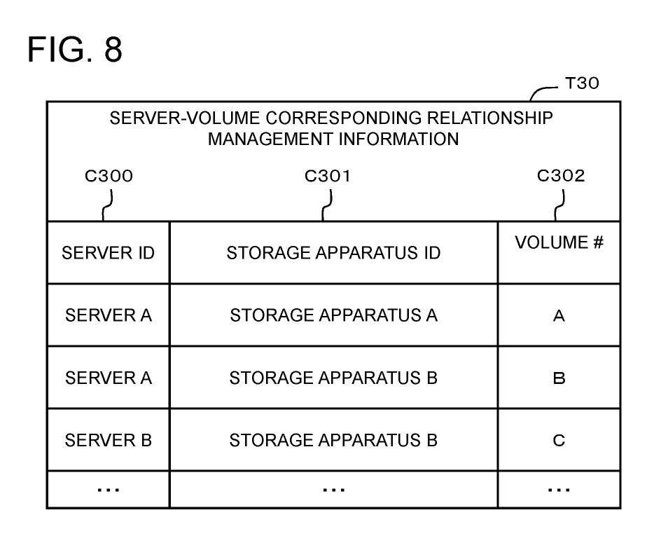

The microprocessor 31 reads and executes a computer program stored in the memory 32. The memory 32 stores a computer program for executing a process 30 for searching for a server, and management information T30 for managing the corresponding relationship between a server and a logical volume. The information T30 for managing the corresponding relationship between a server and a logical volume will be explained further below using FIG. 8.

FIG. 6 shows an example of volume management information T10. The volume management information T10, for example, comprises a volume number column C100, a size column C101, a type column C102, a status column C103, an attribute column C104, a size change result column C105, a post-change size column C106, and a host-response size column C107. The configuration may also be such as to manage items other than these.

The volume number column C100 manages information for the storage apparatus 10 to uniquely identify each logical volume inside the computer system. In the drawing, the number is denoted by “#”. Furthermore, the identification information is not limited to a number, and other information, such as an identification code, may be used.

The size column C101 manages the size (volume size) of a logical volume. The type column C102 denotes the type of a logical volume. The volume types are “normal” and “pool”.

“Normal” denotes that the logical volume is a normal volume. “Pool” denotes that the volume is a volume registered in a pool. In addition, as in the embodiment described below, “Thin Provisioning” can be set in the type column C102 in the case of a virtual volume that uses Thin Provisioning. Also, as in the other embodiment described below, “snapshot” can be set in the type column C102 in the case of a snapshot volume.

The attribute column C104 stores a value showing whether or not a logical volume is being used. For example, in a case where either a logical volume is allocated to the server 20 or a logical volume is being used to expand the size of another logical volume, “allocated” is set in the attribute column C104. In a case where a logical volume is not allocated to a server or another logical volume, “unallocated” is set in the attribute column C104.

The size change result column C105 manages a value that denotes whether a volume size change was a success or a failure. A volume size change comprises a volume size expansion and a volume size reduction. In a case where a volume size change succeeded, “succeeded” is set in the column C105. In a case where a volume size change failed, “failed” is set in the column C105. In a case where the volume size has not been changed, “-” is set in the column C105.

The post-change size column C106 manages the volume size subsequent to a size change. In a case where either a volume size change has not been carried out or a volume size change has failed, the value of the size column C101 and the value of the post-change size column C106 are identical.

The host-response size column C107 manages the volume size in a case where a response is issued to a size query from the server 20.

FIG. 7 shows an example of pair management information T11. The pair management information T11 is for managing a copy pair, and, for example, comprises a pair number column C110, a copy-source volume number column C111, a copy-destination volume number column C112, and a copy pair status column C113. The configuration may also be such as to manage information other than these C110 through C113.

The pair number column C110 manages information for uniquely identifying a copy pair. The copy-source volume number column C111 manages information for identifying a copy-source volume (a primary volume). The copy-destination volume number column C112 manages information for identifying a copy-destination volume (a secondary volume).

The copy pair status column C113 manages information that denotes the status of a copy pair. The copy pair statuses, for example, include “pair”, “PSUS”, “resynch” and “restore”.

FIG. 8 is an example of the information T30 for managing the corresponding relationship between a server and a logical volume. The server-volume corresponding relationship management information T30, for example, comprises a server ID column C300, a storage apparatus ID column C301, and a volume number column C302.

The server ID column C300 manages information for identifying each server 20. The storage apparatus ID column C301 manages information for identifying each storage apparatus 10. The volume number column C302 manages information for identifying a logical volume that is allocated to a server.

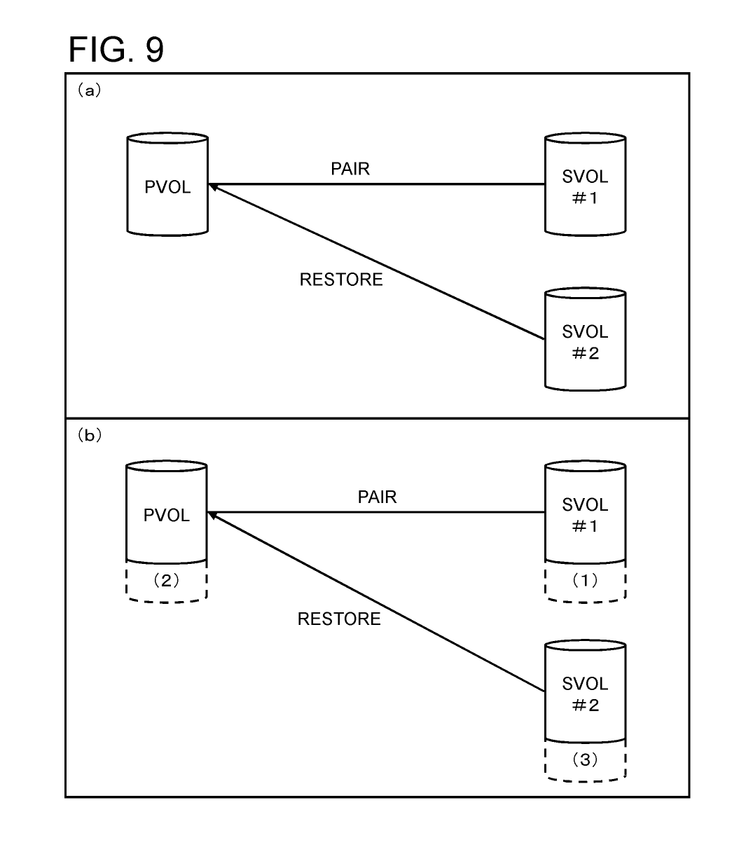

A case in which the size of a volume is expanded will be explained by referring to FIGS. 9 through 14. FIG. 9 shows how the size of a volume is expanded. In FIG. 9 (a), multiple copy pairs comprising a common primary volume are set. A first copy pair is configured from the primary volume and a first secondary volume (#1). A second copy pair is configured from the primary volume and a second secondary volume (#2).

In FIG. 9, it is supposed that the status of the first copy pair is the pair state, and that the status of the second copy pair is the restore state. In accordance with this, as shown in FIG. 9 (b), the size of the first secondary volume (#1) of the first copy pair is first expanded, the size of the primary volume is then expanded, and the size of the second secondary volume (#2) is lastly expanded. The order in which the expansions are made is shown in FIG. 9 (b) using numerals inside the areas to be expanded.

Since the primary volume and the first secondary volume of the first copy pair are in the pair state, the volume sizes can be expanded simultaneously. More specifically, it is preferable that the size of the primary volume, which is the copy source, be expanded subsequent to expanding the size of the first secondary volume, which is the copy destination. This is to prevent losing the data that is to be copied from the primary volume to the first secondary volume.

In contrast to this, a case in which the size of the primary volume is expanded first, and then the size of the first secondary volume is expanded in the first copy pair will be considered. In this case, when the server 20 writes a large amount of data to the primary volume prior to completion of the size expansion of the first secondary volume, there is the possibility that a portion of this large amount of data will not be stored in the first secondary volume. This is because the expansion in the size of the first secondary volume is too late. By contrast, in a case where the size of the first secondary volume, which is the copy destination, is expanded first as described hereinabove, the data transferred from the primary volume is able to be written, making it possible to prevent data loss.

Focus on the second copy pair. The size of the second secondary volume is expanded last after the size of the primary volume has been expanded. This is because in the second copy pair, the primary volume becomes the copy destination (data destination), and the second secondary volume becomes the copy source (data source). To prevent the transfer data from being lost, the size of the second secondary volume, which is the copy source, is expanded after first expanding the size of the primary volume, which is the copy destination.

FIG. 10 is a flowchart showing a process for expanding the size of a volume. This process is executed by the storage apparatus 10.

The storage apparatus 10 receives a command from the management server 30 to expand the size of a volume (S10). This command is equivalent to the “change instruction”. The logical volume specified by this command is equivalent to the “prescribed logical volume”.

The storage apparatus 10 refers to the pair management information T11, and determines whether or not the logical volume for which the volume size expansion was requested is registered in the pair management information T11 (S11). That is, the storage apparatus 10 determines whether or not a copy pair comprising the specified logical volume exists (S11).

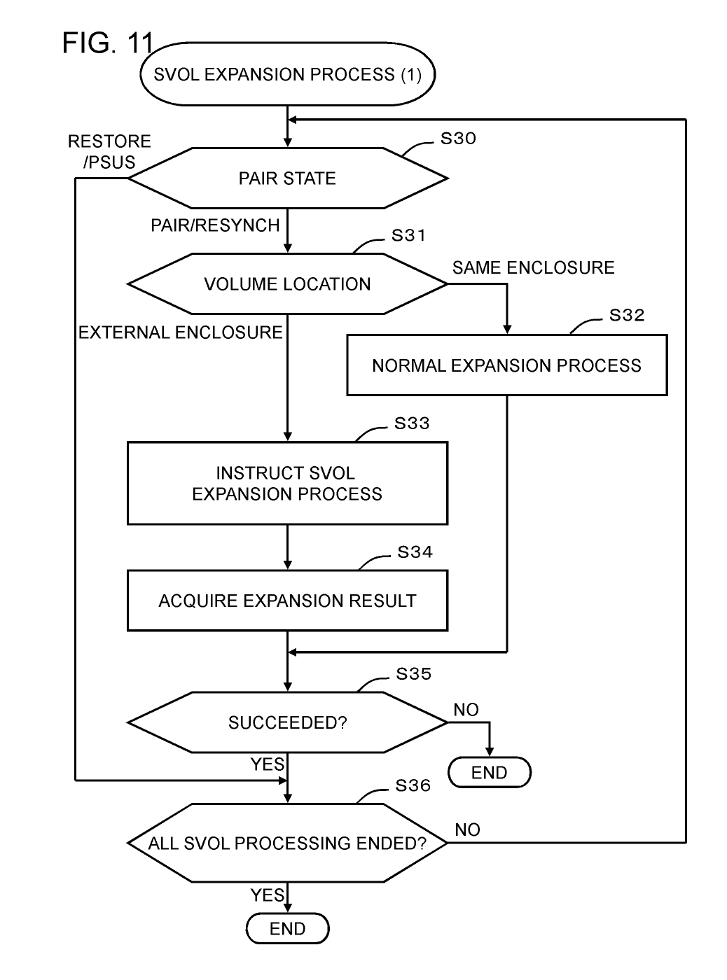

In a case where the copy pair comprising the logical volume specified from the management server 30 exists (S11: YES), an SVOL expansion process (1) is executed (S12). A first SVOL expansion process (1) will be explained in detail using FIG. 11. SVOL is the abbreviation for secondary volume. PVOL is the abbreviation for the primary volume. The SVOL expansion process (1) can also be called a first SVOL expansion process.

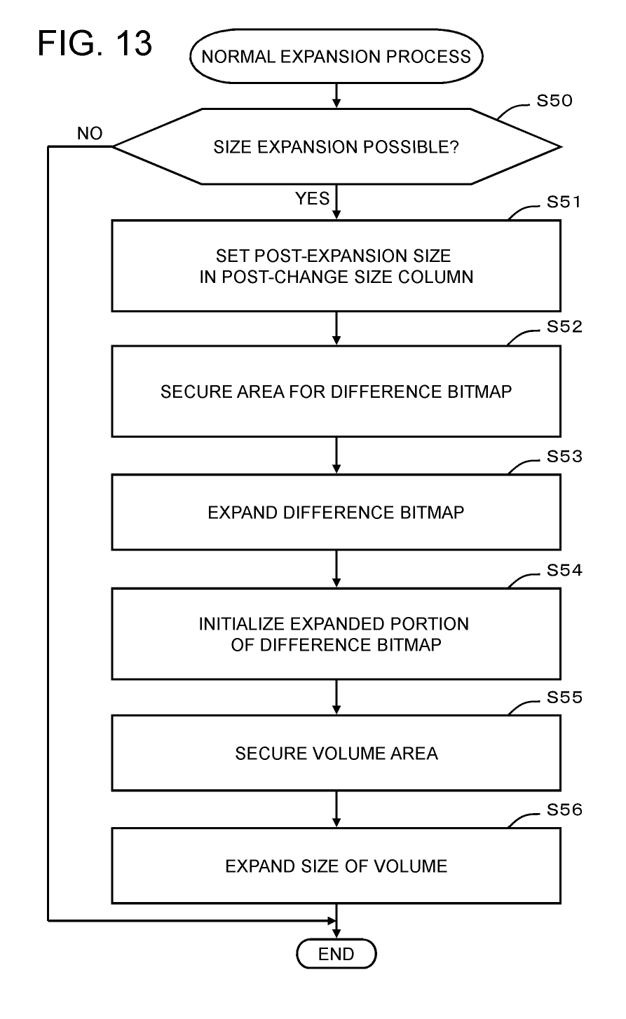

When the first SVOL expansion process has ended, the storage apparatus 10 determines whether or not the first SVOL expansion process was a success (S13). In a case where the first SVOL expansion process was a success (S13: YES), the storage apparatus 10 executes a PVOL expansion process (S14). The PVOL expansion process will be explained in detail further below using FIG. 13.

In a case where a copy pair comprising the logical volume specified from the management server 30 does not exist (S11: NO), the storage apparatus 10 executes the PVOL expansion process (S14). That is, the storage apparatus 10 expands only the size of the specified logical volume to the specified size.

The storage apparatus 10 determines whether or not the PVOL expansion process was a success (S15). In a case where the PVOL expansion process succeeded (S15: YES), the storage apparatus 10 once again refers to the pair management information T11, and determines whether or not another copy pair related to the specified logical volume is registered (S16).

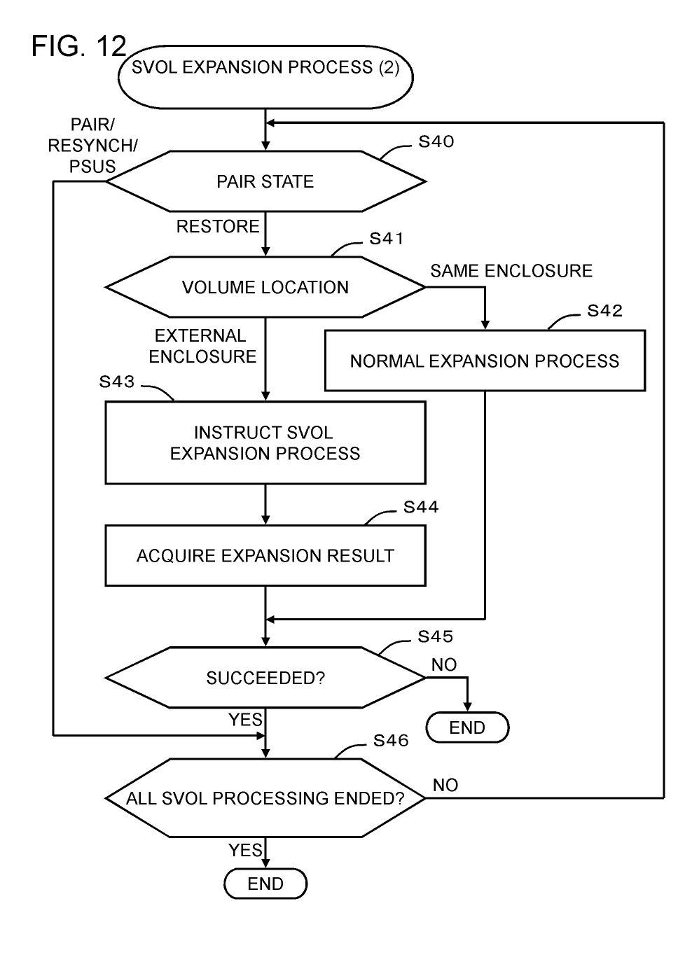

In a case where another copy pair is registered (S16: YES), the storage apparatus 10 executes the SVOL expansion process (2) (S17). The SVOL expansion process (2) will be described in detail using FIG. 12. The SVOL expansion process (2), for example, may also be called the second SVOL expansion process.

The storage apparatus 10 determines whether or not the SVOL expansion process (2) was a success (S18). In a case where the SVOL expansion process (2) succeeded (S18: YES), the storage apparatus 10 ends this processing normally.

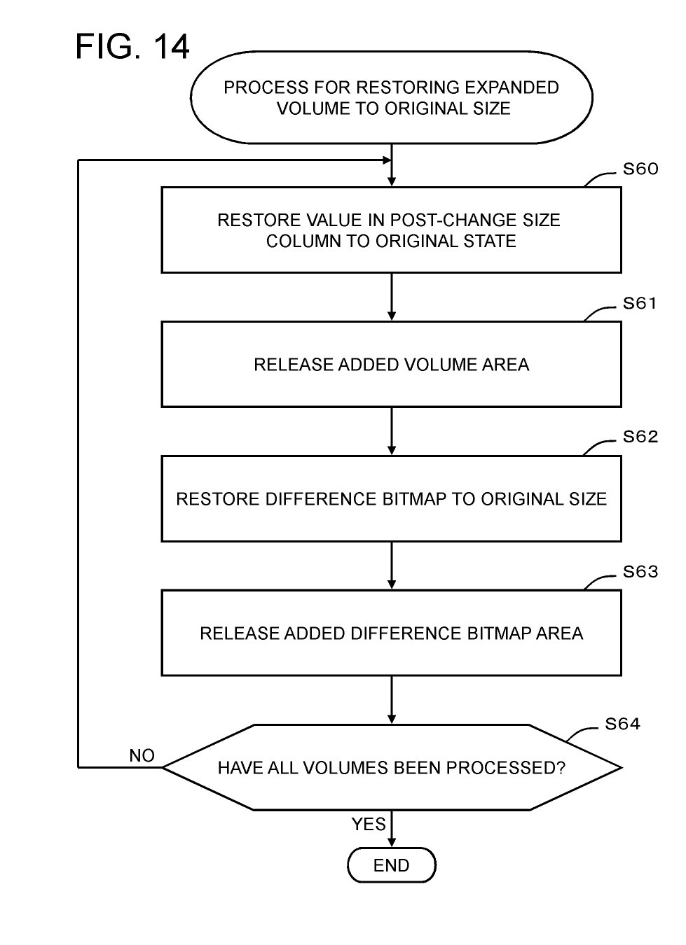

In a case where the SVOL expansion process (1) failed (S13: NO), the PVOL expansion process failed (S15: NO), or the SVOL expansion process (2) failed (S18: NO), the storage apparatus 10 executes a process for restoring the expansion to its original size (S19). Details of S19 will be described using FIG. 14. Furthermore, whether a volume size expansion process (S12, S14, S17) succeeded or not can be determined by referring to the value of the size change result column C105 of the volume management information T10.

FIG. 11 is a flowchart showing details of the SVOL expansion process (1). The storage apparatus 10 refers to the copy pair status column C113 of the pair management information T11, acquires the copy pair status, and determines whether the copy pair status is “pair or resynch” or “restore or PSUS” (S30).

In a case where the copy pair status is either pair or resynch, the storage apparatus 10 determines the mounting location of the copy-destination volume (secondary volume) identified in the copy-destination volume number column C112 (S31).

The secondary volume mounting locations include “same enclosure”, which denotes that the secondary volume is inside the same storage apparatus as the primary volume, and “external enclosure”, which denotes that the secondary volume is inside a different storage apparatus than the primary volume.

In a case where the expansion-target secondary volume exists in the same enclosure as the primary volume, the storage apparatus executes a normal expansion process (refer to FIG. 13) (S32). Alternatively, in a case where the expansion-target secondary volume exists in a different enclosure than the primary volume, the storage apparatus issues a command for instructing a secondary volume size expansion to the other storage apparatus comprising the secondary volume (S33). The other storage apparatus comprising the secondary volume expands the size of the specified secondary volume to the specified value in accordance with this command. The other storage apparatus reports the result of expanding the size of the secondary volume to the command-source storage apparatus (the storage apparatus comprising the primary volume).

The storage apparatus 10 acquires the secondary volume size expansion result from the other storage apparatus (S34), and stores same in the size change result column C105 of the volume management information T10. In a case where the size of the secondary volume inside the same enclosure was expanded, the storage apparatus 10 stores this result in the size change result column C105. The storage apparatus 10 determines whether or not the secondary volume size expansion succeeded based on the value of the size change result column C105 (S35).

In a case where the secondary volume size expansion succeeded (S35: YES), the storage apparatus 10 checks whether or not processing was carried out for all the secondary volumes related to the specified logical volume (primary volume) (S36). In a case where an unprocessed secondary volume exists (S36: NO), the processing returns to S30. In a case where there are no unprocessed secondary volumes (S36: YES), the storage apparatus 10 ends this processing normally.

Ina case where the secondary volume size expansion failed (S35: NO), the storage apparatus 10 ends this processing.

In a case where the secondary volume copy pair status is either restore or PSUS (S30), the storage apparatus 10 moves to S36 without expanding the size of this secondary volume.

In the processing shown in FIG. 11, of the secondary volumes forming copy pairs with the primary volume, the size of the secondary volume, which is either pair or resynch, is expanded prior to the primary volume size expansion (S14) (S32, S33). In a case where the copy pair status is either pair or resynch, the primary volume constitutes the data source, and the secondary volume constitutes the data destination. Therefore, data loss is prevented by expanding the size of the data-destination volume first.

In the case of a secondary volume for which the copy pair status is either restore or PSUS, the size is not expanded in the processing of FIG. 11. The size of a restore state secondary volume is expanded using the processing of FIG. 12.

The size of a secondary volume in the PSUS state is not expanded in the processing of either FIG. 11 or FIG. 12. This is because, when the size a secondary volume that is in the PSUS state is expanded by adding a storage area, it takes time until this added area is actually used, resulting in the added area being useless in the meantime.

FIG. 12 is a flowchart showing the details of the SVOL expansion process (2). The storage apparatus 10 acquires the copy pair status by referring to the pair status column C113 of the pair management information T11, and determines whether the copy pair status is restore, or pair, resynch or PSUS (S40).

A secondary volume size expansion in the case of a copy pair status that is either pair or resynch is implemented using the processing of FIG. 11. In addition, as described hereinabove, in a case where the copy pair status is PSUS, a secondary volume size expansion is put on hold to prevent the useless addition of a storage area. Therefore, the processing of FIG. 12 moves to S46 without carrying out a size expansion for a secondary volume that is any of pair, resynch, or PSUS.

In a case where the copy pair status is restore, the storage apparatus 10 determines whether the mounting location of this secondary volume in the computer system is the same enclosure or an external enclosure the same as described using FIG. 11 (S41).

In a case where a restore-state secondary volume exists in the same enclosure as the primary volume, the storage apparatus 10 executes a normal expansion process (S42) (refer to FIG. 13). In a case where a restore-state secondary volume exists in an external enclosure, the storage apparatus 10 issues to the other storage apparatus comprising the secondary volume a command for instructing a secondary volume size expansion (S43). The other storage apparatus (external enclosure) expands the size of the specified secondary volume to the specified value in accordance with this command. The other storage apparatus reports the secondary volume size expansion result to the command-source storage apparatus.

The storage apparatus 10 acquires the secondary volume size expansion result from the other storage apparatus (S44), and stores this result in the size change result column C105 of the volume management information T10. The same as was described using FIG. 11, in a case where the size of the secondary volume inside the same enclosure was expanded, the storage apparatus 10 stores this result in the size change result column C105. The storage apparatus 10 determines whether or not the secondary volume size expansion succeeded based on the value in the size change result column C105 (S45).

In a case where the secondary volume size expansion succeeded (S45: YES), the storage apparatus 10 checks whether or not processing has been carried out for all of the secondary volumes related to the specified logical volume (primary volume) (S46). In a case where an unprocessed secondary volume exists (S46: NO), the processing returns to S40. In a case where there are no unprocessed secondary volumes (S46: YES), the storage apparatus 10 ends this processing normally.

In a case where the secondary volume size expansion failed (S45: NO), the storage apparatus 10 ends this processing.

In a case where the copy pair status of the secondary volume is any of pair, resynch, or PSUS (S40), the storage apparatus 10 moves to S46 without expanding the size of the secondary volume as described hereinabove.

FIG. 13 is a flowchart of a normal expansion process. The normal expansion process is executed with the PVOL expansion process shown in FIG. 10 (S14), the normal expansion process shown in FIG. 11 (S32), and the normal expansion process shown in FIG. 12 (S42).

The storage apparatus 10 determines whether or not it is possible to expand the size of the volume that constitutes the target of the size expansion (hereinafter, the expansion-target volume) (S50). Whether a volume size expansion is possible or not is determined based on the size of the free area in the storage device 121 and the size of the free area in the memory 111.

Anew storage area must be added to the expansion-target volume in order to make the size of the expansion-target volume larger. Therefore, the determination criterion becomes whether or not the size of the storage device 121 free area is large enough. In addition, since the address space of the expansion-target volume will also expand when the size of this volume is made larger, the size of the difference bitmap T12 must also be expanded in accordance with the expansion of the address space. Therefore, whether or not a new memory area is able to be added to the difference bitmap T12 also becomes a determination criterion.

In a case where either the free area of the storage device 121 is not enough or the free area of the memory 111 is too small, it is not possible to expand the size of the expansion-target volume (S50: NO). Therefore, the storage apparatus 10 ends this processing.

In a case where the size of the expansion-target volume is able to be expanded (S50: YES), the storage apparatus 10 sets the post-expansion volume size in the post-change size column C106 of the volume management information T10 (S51).

The storage apparatus 10 secures an area from the free area of the memory 111 to be added to the difference bitmap T12 (S52). The storage apparatus 10 secures a free area of a size that corresponds to the volume size to be expanded. The storage apparatus 10 expands the size of the difference bitmap T12 by connecting the secured free area to the difference bitmap T12 (S53).

The storage apparatus 10 initializes the part of the difference bitmap T12 that was expanded in S53 (S54). The storage apparatus 10 sets a value denoting that there is a difference in the expanded part of the difference bitmap T12 to make the storage contents of the copy-source volume and the copy-destination volume completely identical. In accordance with this, the data of the expanded part is transferred to and stored in the size-expanded copy-destination volume from the size-expanded copy-source volume when a resynch process is executed thereafter.

The storage apparatus 10 secures a volume area (either a free area of the storage device 121 or a logical storage area obtained by virtualizing this free area) to be added to the expansion-target volume (S55). The storage apparatus 10 expands the size of the expansion-target volume by linking the secured volume area to the expansion-target volume (S56). The storage apparatus 10 updates the value of the post-change size column C106 of the volume management information T10 to the post-expansion size, and ends this processing.

FIG. 14 is a flowchart showing the process (S19 of FIG. 10) for restoring an expansion to its original size. In a case where the expansion of the size of even one of the logical volumes related to the size expansion failed, the expansion is restored to its original size to make the sizes of the respective volumes configuring the copy pair identical.

The storage apparatus 10 changes the value of the post-change size column C106 of the volume management information T10 to the original value of prior to the size expansion (S60). Next, the storage apparatus 10 disconnects and releases from the expansion-target volume the volume area that was added to the expansion-target volume (S61).

For example, in a case where another logical volume had been added to the expansion-target volume, the storage apparatus 10 changes the value of the attribute column C104 of the added logical volume from “allocated” to “unallocated”.

Next, the storage apparatus 10 disconnects from the difference bitmap T12 the memory area that was added to the difference bitmap T12, and restores the difference bitmap T12 to its original size (S62). The storage apparatus 10 releases the disconnected memory area, and restores the logical volume to the unallocated status (S63).

The storage apparatus 10 determines whether or not the restore-to-original process was executed for all the logical volumes that had been expanded (S64). The storage apparatus 10 checks to make sure that the values in the size columns C101 and the values in the post-change size columns C106 are identical for all the volumes comprising copy pairs related to the primary volume that requested the size expansion.

In a case where all the volumes related to the copy pair have been restored to their original sizes (S64: YES), the storage apparatus 10 ends this processing. In a case where there is a volume for which the value of the size column C101 and the value of the post-change size column C106 do not match (S64: NO), that is, when there is a volume that has not been restored to the pre-expansion size, the processing returns to S60.

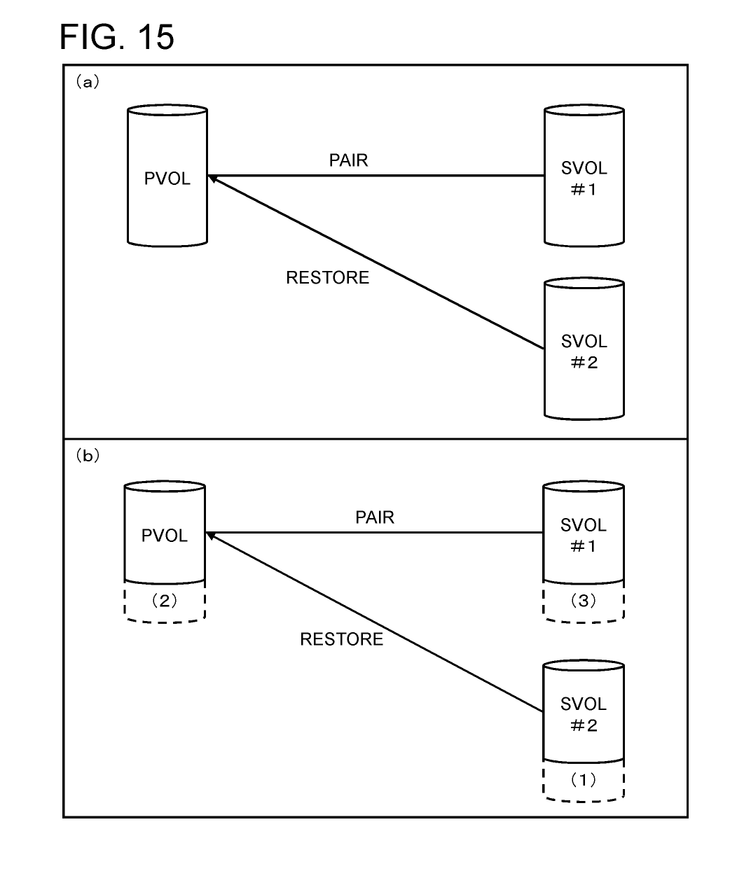

A case in which a volume size is reduced will be explained by referring to FIGS. 15 through 21. FIG. 15 shows how to reduce the size of a volume. In FIG. 15 (a), as was described using FIG. 9, multiple copy pairs comprising a common primary volume are set. A first copy pair is configured from the primary volume and a first secondary volume (#1). A second copy pair is configured from the primary volume and a second secondary volume (#2).

In FIG. 15, it is supposed that the status of the first copy pair is the pair state, and the status of the second copy pair is the restore state. In this case, as shown in FIG. 15 (b), the size of the second secondary volume (#2) is first reduced, the size of the primary volume is then reduced, and the size of the first secondary volume (#1) is lastly reduced.

In the case of restore, failure to reduce the volume size of the second secondary volume (#2), which is the copy source, before that of the primary volume, which is the copy destination, could result in lost data. This is because the data transferred to the copy destination could be lost as a result of the size reduction. Reducing the size of the copy-source volume first results in the data of the area that is reduced (the reduced area) not being transferred to the copy destination. Therefore, data loss does not occur.

The same holds true in the case of pair. The size of the copy-source primary volume is first reduced, and the size of the copy-destination first secondary volume (#1) is then reduced.

FIG. 16 is a flowchart showing a volume size reduction reservation process, which is carried out prior to a size reduction. In the reduction reservation process, the size presented to the server 20 (the value of the host-response size column C107 of FIG. 6) is changed first before actually reducing the size of a reduction-target volume.

The storage apparatus 10 receives from the management server 30 a command for reserving a volume size reduction (S70). The storage apparatus 10 determines whether or not it is possible to reduce the size of the logical volume specified in this command (S71). For example, the storage apparatus 10 determines whether or not the reduction-target area is included in an unallocated area of the storage area of the specified logical volume (S71). That is, the storage apparatus 10 determines whether or not the area scheduled to be reduced is an unallocated area.

Information as to whether or not the area targeted for reduction (may also be called the reduction-target area) is an area that is not being used by the server 20 is acquired from the server 20. For example, the server 20 is able to notify the storage apparatus 10 via the management server 30 about information related to a free area in accordance with a defragmentation process. The management server 30 may create a command comprising information related to this free area and send this information to the storage apparatus 10.

In a case where it is determined that a size reduction is possible (S71: YES), the storage apparatus 10 respectively sets the post-reduction size related to the reduction-target volume (the primary volume) as the value of the post-change size column C106 and as the value of the host-response size column C107 of the volume management information T10 (S72). The point to be careful of here is that the size reduction process has not been executed yet. The value of the volume size presented to the server 20 is reduced first before the volume size is reduced.

Next, the storage apparatus 10 refers to the pair management information T11 and determines whether or not a copy pair exists for the volume specified as the reduction target (S73). In a case where a copy pair has not been set (S73: NO), this processing ends.

In a case where a copy pair has been set (S73: YES), the storage apparatus 10 determines the copy pair status (S74). In a case where the copy pair status is any of pair, resynch, or restore, the storage apparatus 10 determines whether or not it is possible to reduce the size of a secondary volume (S75). In a case where the copy pair status is PSUS, the storage apparatus 10 moves to S77.

The same as the determination as to the advisability of a primary volume size reduction, a determination that a size reduction is possible can be made when the area of the secondary volume scheduled to be reduced is an unused area.

In a case where it is possible to reduce the size of the secondary volume (S75: YES), the storage apparatus 10 respectively sets the post-reduction size related to the secondary volume as the value of the post-change size column C106 and as the value of the host-response size column C107 of the volume management information T10 (S76).

The storage apparatus 10 determines whether or not the processing has been carried out for all of the secondary volumes related to the reduction-target primary volume (S77). In a case where there is an unprocessed secondary volume (S77: NO), the processing returns to S74. When there are no unprocessed secondary volumes (S77: YES), this processing ends.

In a case where either the primary volume size reduction is not possible (S71: NO) or the primary volume size reduction is not possible (S75: NO), a process for cancelling the reduction reservation and returning to the original state (S78) is executed.

FIG. 17 is a flowchart showing the process (S78) for restoring the reduction reservation to its original state in detail. The storage apparatus 10 respectively restores the value of the post-change size column C106 and the value of the host-response size column C107 of the volume management information T10 to the value stored in the size column C101, which is the original value (S80).

The storage apparatus 10 determines whether or not processing has been carried out for all the volumes related to the reduction reservation (S81). The storage apparatus 10 checks to make sure that the value of the post-change size column C106 and the value of the host-response size column C107 are identical to the value of the size column C101 for all the volumes related to the reduction reservation (S81: YES), and ends this processing. In a case where an unprocessed volume remains (S81: NO), the processing returns to S80.

FIG. 18 is a flowchart showing the process for reducing a volume size. The storage apparatus 10 receives a command for reducing a volume size from the management server 30 (S90). This command is equivalent to the “change instruction”. The logical volume that is specified in the reduction command is equivalent to the “prescribed logical volume”.

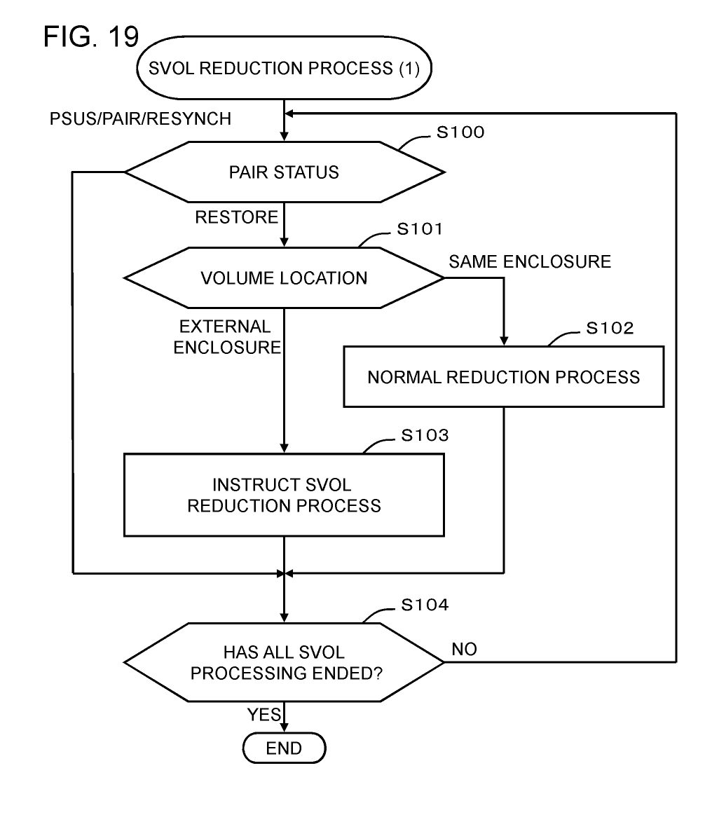

The storage apparatus 10 refers to the pair management information T11, and determines whether or not a copy pair is set for the logical volume that requested the volume size reduction (S91). In a case where a copy pair is set (S91: YES), the storage apparatus 10 executes a SVOL reduction process (1) (S92). The SVOL reduction process (1) can also be called the first SVOL reduction process. The SVOL reduction process (1) will be explained in detail using FIG. 19.

In a case where a copy pair has not been set for the reduction-target volume (S91: NO), the storage apparatus 10 skips S92 and proceeds to S93.

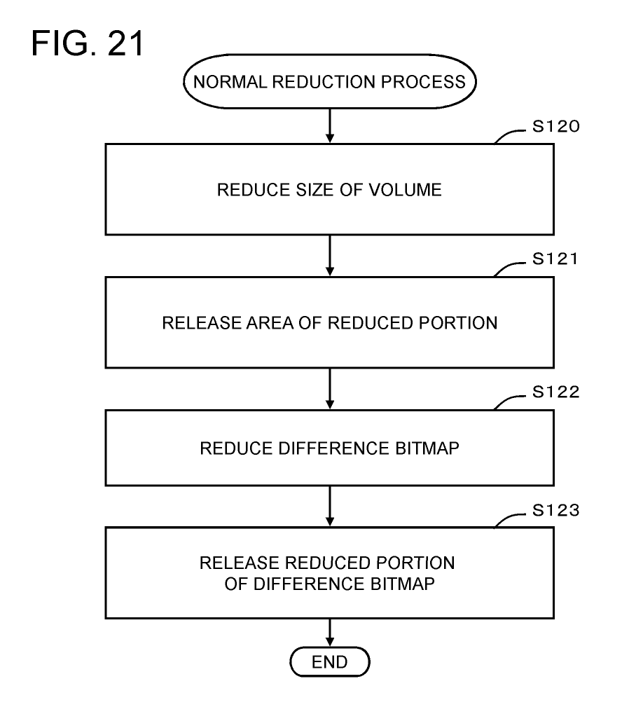

The storage apparatus 10 executes a PVOL reduction process (S93). The PVOL reduction process will be explained in detail using FIG. 21.

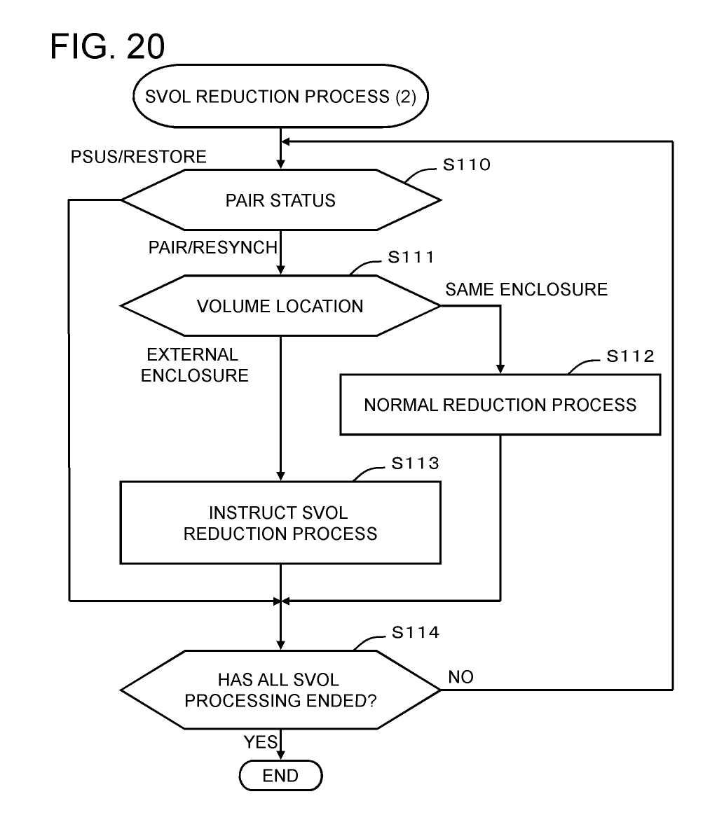

The storage apparatus 10 refers to the pair management information T11 once again after the PVOL reduction process, and determines whether or not another copy pair is set for the specified logical volume (S94). In a case where another copy pair is set (S94: YES), the storage apparatus 10 executes a SVOL reduction process (2). The SVOL reduction process (2) will be explained in detail using FIG. 20. The SVOL reduction process (2), for example, can also be called the second SVOL reduction process. In a case where another copy pair does not exist (S94: NO), this processing ends.

FIG. 19 is a flowchart showing the SVOL reduction process (1) in detail. The storage apparatus 10 refers to the copy pair status column C113 of the pair management information T11, acquires the copy pair status, and determined whether the copy pair status is “restore”, or “PSUS, pair, or resynch” (S100).

In a case where the copy pair status is restore, the storage apparatus 10 determines the mounting location of the secondary volume (S101). In a case where the secondary volume is disposed in the same enclosure as the primary volume, the storage apparatus 10 executes a normal reduction process (S102) (refer to FIG. 21).

In a case where the secondary volume exists in a storage apparatus that is different from the storage apparatus in which the primary volume is disposed, the storage apparatus 10 instructs this other storage apparatus to reduce the size of the secondary volume (S103).

The storage apparatus 10 checks whether or not processing has been carried out for all of the secondary volumes related to the specified logical volume (the primary volume) (S104). When an unprocessed secondary volume exists (S104: NO), the processing returns to S100. When there are no unprocessed secondary volumes (S104: YES), this processing ends.

FIG. 20 is a flowchart showing the SVOL reduction process (2) in detail. The storage apparatus 10 acquires the copy pair status from the copy pair status column C113 of the pair management information T11, and determines whether the copy pair status is either “pair or resynch” or “PSUS or restore” (S110).

In a case where the copy pair status is either pair or resynch, the storage apparatus 10 determines the mounting location of the secondary volume (S111). The same as was described using FIG. 19, when the secondary volume is disposed in the same enclosure as the primary volume, the storage apparatus 10 executes a normal reduction process (S112) (refer to FIG. 21).

In a case where the secondary volume exists in a storage apparatus that is different from the storage apparatus in which the primary volume is disposed, the storage apparatus 10 instructs this other storage apparatus to reduce the size of the secondary volume (S113).

The storage apparatus 10 checks whether or not processing has been carried out for all of the secondary volumes related to the specified logical volume (the primary volume) (S114). When an unprocessed secondary volume exists (S114: NO), the processing returns to S100. When there are no unprocessed secondary volumes (S114: YES), this processing ends.

FIG. 21 is a flowchart of the normal reduction process. The normal reduction process is executed with the PVOL reduction process shown in FIG. 18 (S93), the normal reduction process shown in FIG. 19 (S102), and the normal reduction process shown in FIG. 20 (S112).

The storage apparatus 10 determines whether or not it is possible to reduce the size of the volume that constitutes the target of the size reduction (hereinafter, the reduction-target volume), and when a reduction is determined to be possible, sets a post-reduction size in the value of the size column C101 for the reduction-target volume (S120).

The determination as to whether or not a reduction is possible, for example, can be made based on whether the reduction-target area is a free area that is not being used. In addition, in a case where a volume the size of the reduction-target area or larger has been previously added to the reduction-target volume, a determination that reduction is possible can be made when an unused area inside this added volume is the reduction-target size or larger.

The storage apparatus 10 releases and restores the reduction-target area (the area to be deleted from the volume) to the unused state (unallocated state) (S121). For example, the storage apparatus 10 disconnects the logical volume that had been added to the reduction-target volume from the reduction-target volume, and sets “unallocated” as the value in the attribute column C104.

In addition, the storage apparatus 10 disconnects a memory area of the prescribed size from the difference bitmap T12, and reduces the size of the difference bitmap T12 (S122). The storage apparatus 10 changes the state of the disconnected memory area to the unused state, and releases this memory area (S123).

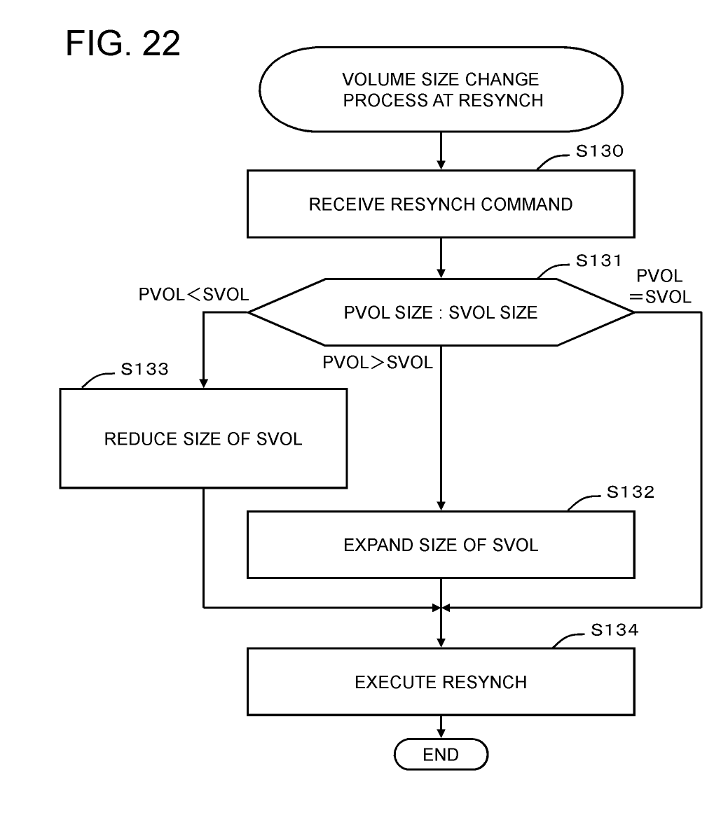

FIG. 22 shows a process for changing a volume size at the time of the restore process. In this embodiment, the size of one or multiple logical volumes comprising a copy pair is changed based on the status of the copy pair. In the case of the PSUS state, only the size of the primary volume is changed; the size of the secondary volume is not changed. This is to shorten the time that the storage area added to the secondary volume is of no use, and to raise the utilization efficiency of the storage area.

In order to transition from the PSUS state to the pair state, the date stored in the primary volume and the data stored in the secondary volume must be made identical. The resynch process is carried out for this purpose. In this embodiment, when changing the volume size of a PSUS-state copy pair, only the size of the primary volume comprising this copy pair is changed, and the size of the secondary volume is not changed. Therefore, the size of the primary volume and the size of the secondary volume do not match at the start of the resynch process. Accordingly, in the processing shown in FIG. 22, the size of the primary volume and the size of the secondary volume are made identical prior to the resynch.

The storage apparatus 10, upon receiving a resynch command from the management server 30 (S130), compares the sizes of the primary volume and the secondary volume, which are the targets of the resynch process (S131).

In a case where the size of the primary volume is larger than the size of the secondary volume, the storage apparatus 10 expands the size of the secondary volume to make the size of the secondary volume identical to the size of the primary volume (S132). In S132, a normal expansion process (refer to FIG. 13) can be used to expand the size of the secondary volume up to the size of the primary volume.

In a case where the size of the primary volume is smaller than the size of the secondary volume, the storage apparatus 10 reduces the size of the secondary volume to make the size of the secondary volume identical to the size of the primary volume (S133). In S133, a normal reduction process (refer to FIG. 21) can be used to reduce the size of the secondary volume down to the size of the primary volume.

As described hereinabove, after making the size of the primary volume and the size of the secondary identical on the basis of the primary volume, which is the source of the data (copy source), the storage apparatus 10 executes the resynch process (S134). The storage apparatus 10 uses the difference bitmap T12 to copy difference data from the primary volume to the secondary volume.

Furthermore, in a case where the size of the primary volume and the size of the secondary volume are identical from the start, the storage apparatus 10 moves from S131 to S134.

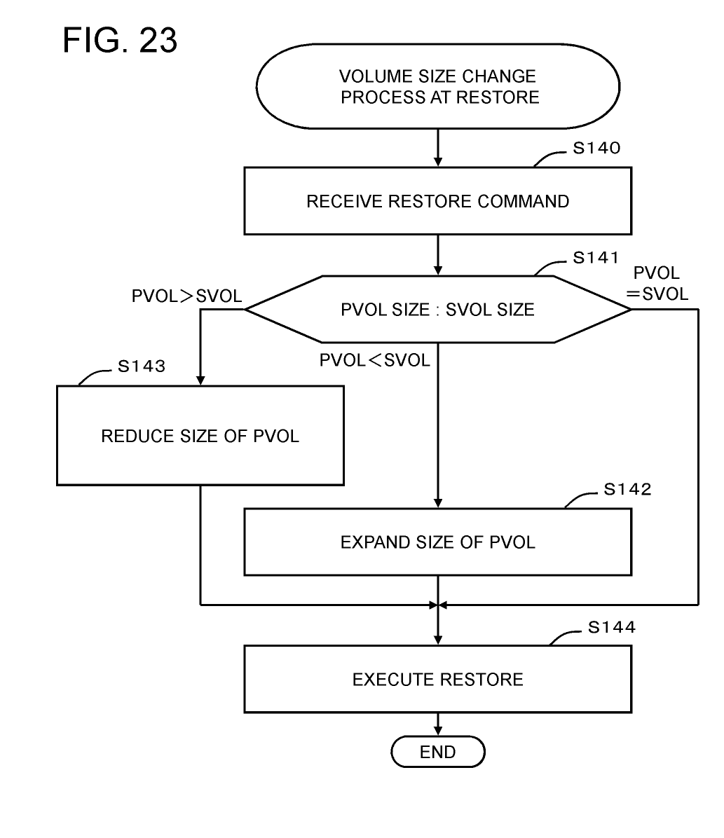

FIG. 23 shows a process for changing a volume size at the time of a restore process. For the same reason as was described using FIG. 22, when transitioning from the PSUS state to the restore state, the size of the primary volume and the size of the secondary volume do not match.

Accordingly, the storage apparatus 10, upon receiving a restore command from the management server 30 (S140), compares the sizes of the primary volume and the secondary volume, which constitute the targets of the restore process (S141).

In a case where the size of the primary volume is smaller than the size of the secondary volume, the storage apparatus 10 expands the size of the primary volume to make the size of the primary volume identical to the size of the secondary volume (S142). In S142, a normal expansion process (refer to FIG. 13) can be used to expand the size of the primary volume up to the size of the secondary volume.

In a case where the size of the primary volume is larger than the size of the secondary volume, the storage apparatus 10 reduces the size of the primary volume to make the size of the primary volume identical to the size of the secondary volume (S143). In S143, a normal reduction process (refer to FIG. 21) can be used to reduce the size of the primary volume down to the size of the secondary volume.

The same as the process of FIG. 22, in this process, too, the storage apparatus 10 executes the restore process (S144) after making the size of the primary volume and the size of the secondary volume identical on the basis of the secondary volume, which is the source of the data (copy source).

Furthermore, in a case where the size of the primary volume and the size of the secondary volume are identical from the start, the storage apparatus 10 moves from S141 to S144.

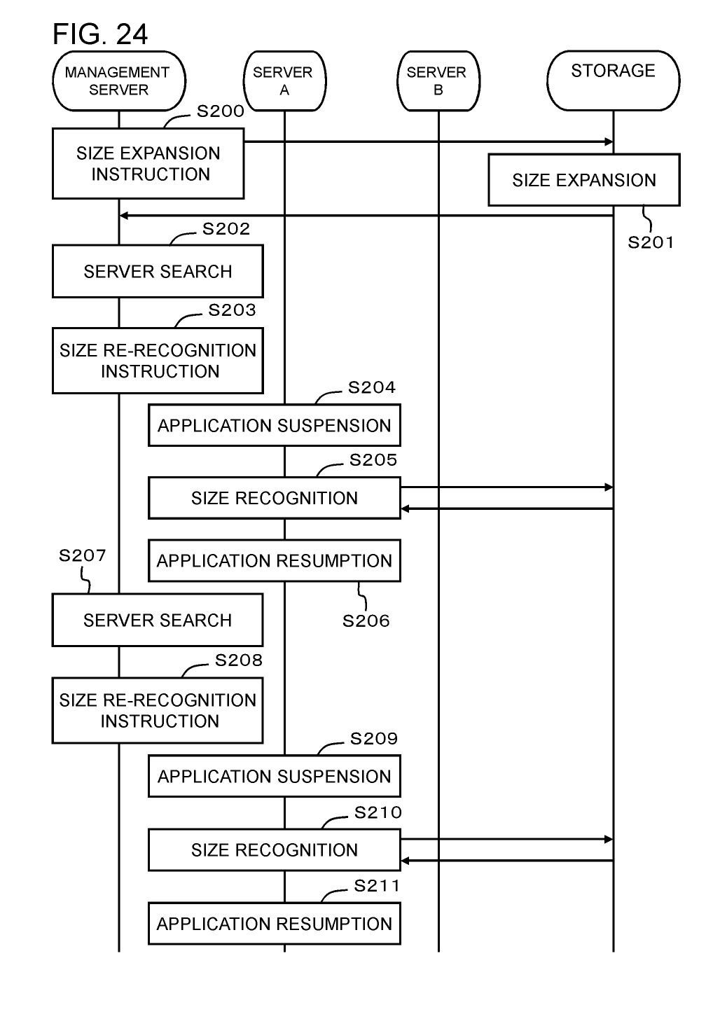

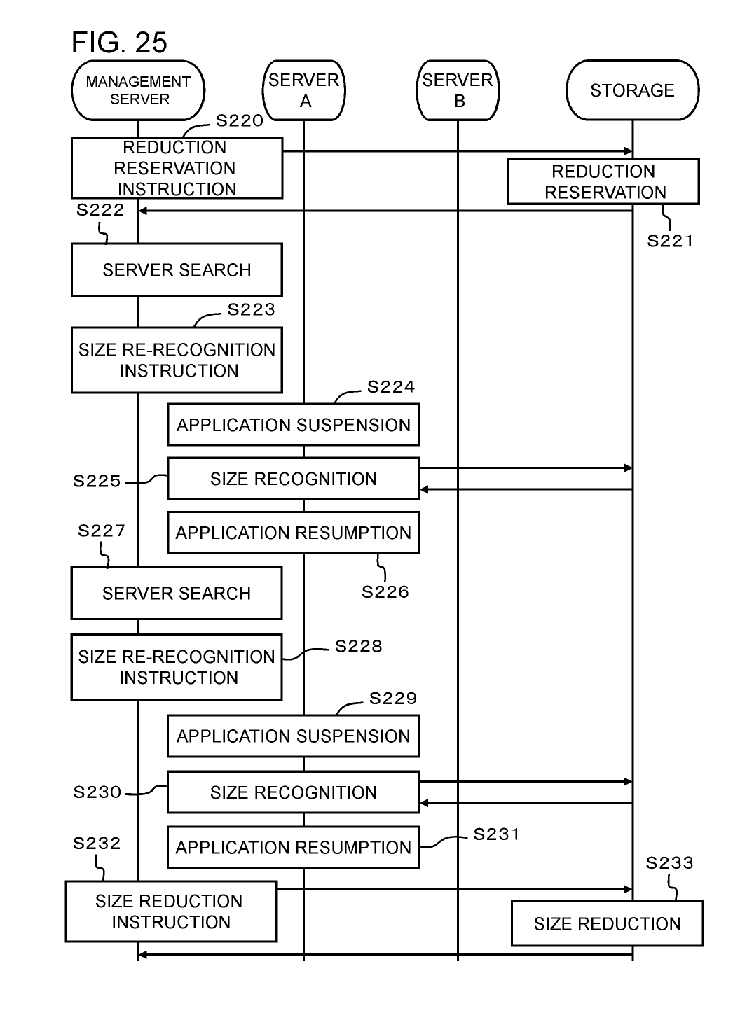

FIG. 24 is a sequence diagram showing the overall process when expanding the size of a volume. For convenience sake, only one storage apparatus is shown in FIGS. 24 and 25.

The management server 30 instructs the storage apparatus 10 comprising the expansion-target volume to expand the size of the volume (S200). The storage apparatus 10 expands the size of the specified logical volume in accordance with this instruction (S201). As described hereinabove, in this embodiment, an expansion-target volume is selected on the basis of the copy pair status, and the volume size is expanded in a prescribed order. For example, the copy-destination volume is expanded first, and the copy-source volume is expanded afterwards.

The management server 30, upon confirming that the volume size expansion process by the storage apparatus 10 is complete, refers to the server-volume corresponding relationship management information T30 described using FIG. 8, and searches for the server 20A that is using the size-expanded logical volume (S202). The management server 30 instructs the server 20A using the size-expanded logical volume to re-recognize the volume size (S203).

The server 20A, upon receiving the re-recognition instruction from the management server 30, suspends the application program (S204), and issues a command to the storage apparatus 10 to query the volume size (S205).

The storage apparatus 10 responds with the size of the logical volume that is being used by the server 20A. The server 20A, upon acquiring the volume size from the storage apparatus 10, resumes the operation of the application program (S206).

The management server 30 refers to the server-volume corresponding relationship management information T30 once again, and searches for another server 20B that is using a logical volume that has had the volume size expanded (S207). The management server 30 instructs the server 20B using the size-expanded logical volume to re-recognize the volume size (S208).

The server 20B, upon receiving the re-recognition instruction, suspends the application program (S209), and issues a command to the storage apparatus 10 to query the volume size (S210).

The storage apparatus 10 responds with the size of the logical volume that is being used by the server 20B. The server 20B, upon acquiring the volume size from the storage apparatus 10, resumes the operation of the application program (S211).

FIG. 25 is a sequence diagram showing the overall process when reducing the size of a volume.

First of all, the management server 30 sends an instruction to the storage apparatus 10 to execute the reduction reservation process (S220). The storage apparatus 10 that receives this instruction executes the reduction reservation process (S221). That is, the storage apparatus 10 changes the value of the “host-response size column C107” related to the reduction-target volume to the post-reduction process value regardless of the fact that it is prior to the reduction process.

The management server 30 refers to the server-volume corresponding relationship management information T30 and searches for the server 20A that is using the size-reduced logical volume (S222). The management server 30 instructs the server 20A to re-recognize the volume size (S223).

The server 20A, upon receiving the re-recognition instruction, suspends the application program (S224), and issues a command to the storage apparatus 10 to query the volume size (S225). The storage apparatus 10 responds with the size of the logical volume that is being used by the server 20A. The server 20A, upon acquiring the volume size from the storage apparatus 10, resumes the operation of the application program (S226).

The management server 30 refers to the server-volume corresponding relationship management information T30 once again and searches for another server 20B that is using a logical volume that has had the volume size expanded (S227). The management server 30 instructs the server 20B to re-recognize the volume size (S228).

The server 20B, upon receiving the re-recognition instruction, suspends the application program (S229) and issues a command to the storage apparatus 10 for querying the volume size (S230). The storage apparatus 10 responds with the size of the logical volume that is being used by the server 20B. The server 20B, upon acquiring the volume size from the storage apparatus 10, resumes the operation of the application program (S231).

The management server 30, after causing the respective servers 20A, 20B to recognize the sizes of the reduction-target volumes, instructs the storage apparatus 10 to reduce the volume sizes (S232). The storage apparatus 10 decides the reduction-target volumes based on the copy pair status, and reduces the sizes thereof (S233).

In accordance with configuring this embodiment like this, it is possible to curb the wasteful addition of a storage area by taking the copy pair status into consideration in the selection of a volume that is to undergo a size change from among multiple volumes configuring a copy pair. Therefore, it is possible to effectively utilize the storage area of a storage apparatus to change the size of logical volumes configuring the copy pair without releasing the copy pair setting.

Furthermore, by taking the copy pair status into consideration to decide the size change order of the respective logical volumes that are targeted for change, it is possible to prevent data loss and to enhance reliability.

In addition, in this embodiment, since the time period of the volume size change is aligned with the time period for the volume size to be recognized by the server, the occurrence of errors caused by volume size recognition errors can be suppressed.

In this embodiment, in a case where the volume size is to be reduced, the server is made to re-recognize the volume size after the value of the volume size presented to the server 20 has been made smaller, and the volume size is reduced thereafter. That is, the actual volume size is reduced after making the server recognize the post-reduction volume size. Therefore, for example, the storage apparatus does not receive an I/O targeted at a pre-reduction volume after the volume size has been reduced, thereby making it possible to suppress the occurrence of errors.

### Embodiment 2

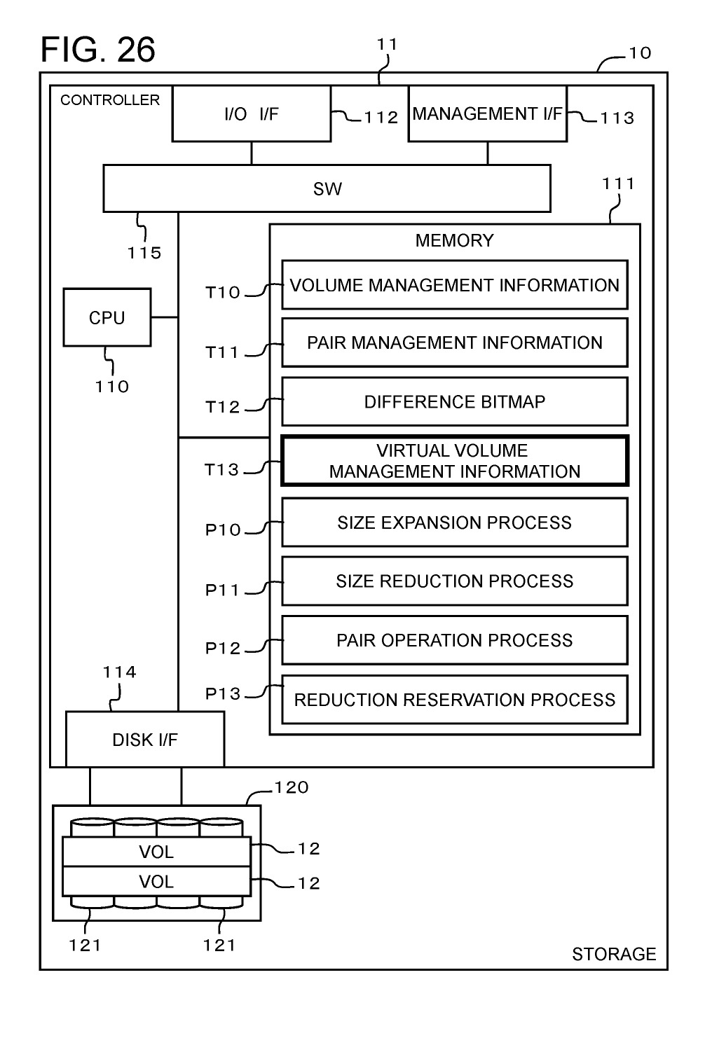

A second embodiment will be explained by referring to FIGS. 26 through 31. The following embodiments, to include this embodiment, are equivalent to variations of the first embodiment. Therefore, the respective flowcharts explained in the first embodiment can be used as needed in the following embodiments. The following explanation will focus on the differences with the first embodiment. In this embodiment, the size of a logical volume created using Thin Provisioning technology will be changed.

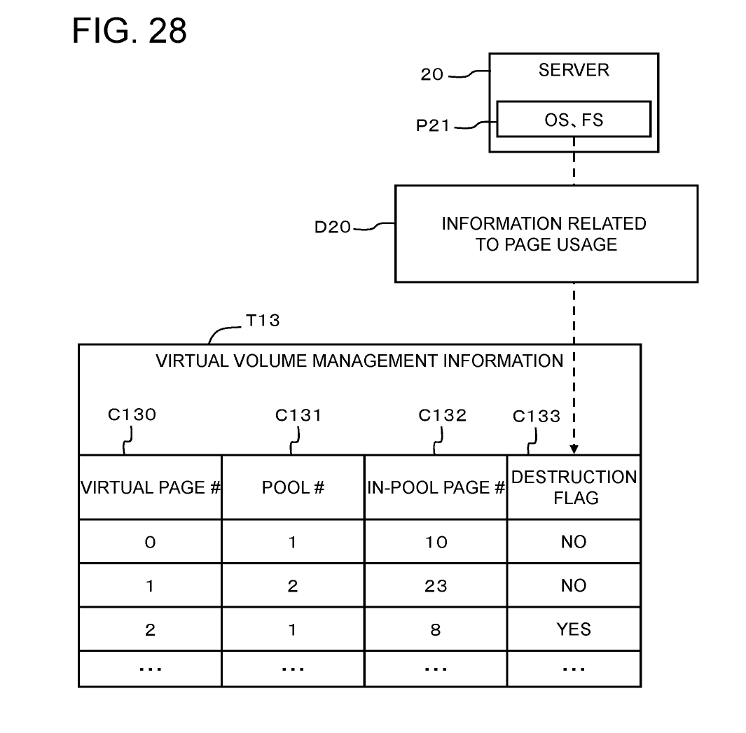

FIG. 26 shows the configuration of a storage apparatus 10 according to this embodiment. The memory 111 stores information T13 for managing a virtual volume. The management information T13 will be explained in detail using FIG. 28. A virtual volume 124, for example, may also be called a Thin Provisioning volume. The virtual volume 124 will be denoted as VVOL in the drawings.

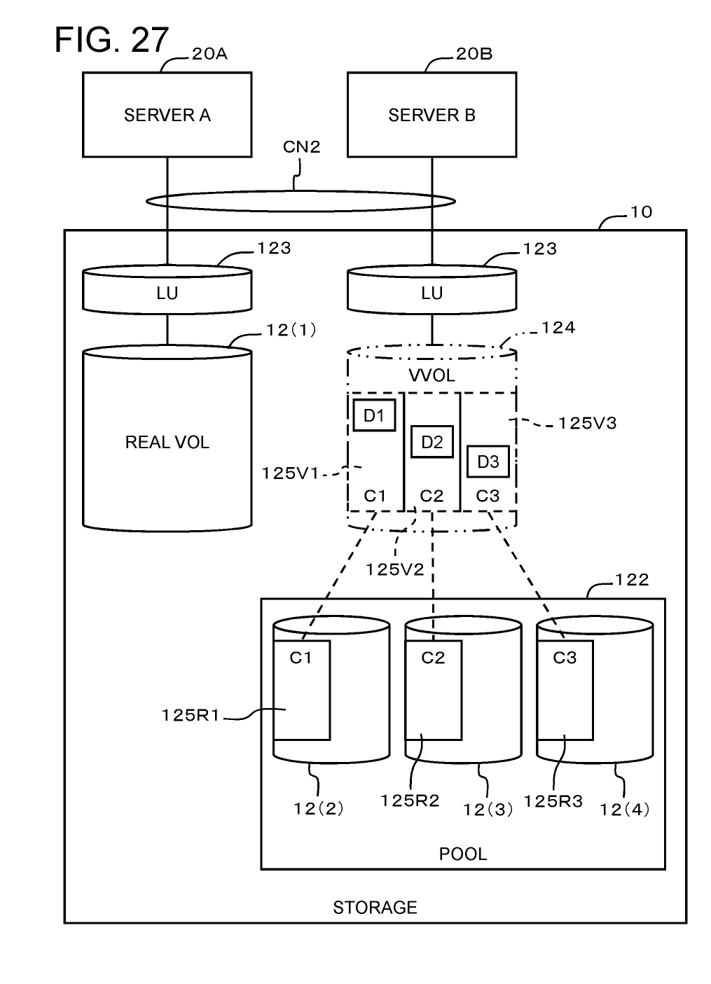

FIG. 27 schematically shows the mechanism of the virtual volume 124. The virtual volume 124 is a virtually created logical volume, and is provided to the server 20B via a LU 123. In the server 20A, an ordinary logical volume 12(1) is provided to the server 20A. The ordinary logical volume is created based on an identified storage area of the storage device 121.

By contrast, the virtual volume 124 exists virtually, and in a case where data is written to a virtual storage area (may also be called a virtual page) from the server 20B, a real storage area (may also be called a real page) for storing this data is selected from a pool 122 and associated with the virtual volume 124.

When the server 20B writes data D1 through D3 to the virtual storage areas 125V1 through 125V3 of the virtual volume 124, the real storage areas 125R1 through 125R3 are selected from the real volumes 12(2), 12(3) and 12(4) that are stored in the pool 124. The virtual storage areas 125V1 through 125V3 are associated with the real storage areas 125R1 through 125R3, and the data D1 through D3 is stored in the real storage areas 125R1 through 125R3.

Since utilizing Thin Provisioning technology like this allocates only the portion of the real storage area that the server 20B actually used to the virtual volume 124, the real storage area can be used effectively.

FIG. 28 shows an example of the virtual volume management information T13. The virtual volume management information T13, for example, comprises a virtual page number column C130, a pool number column C131, an in-pool page number column C132, and a destruction flag C133.

The virtual page number column C130 manages information for identifying virtual pages 125V1 through 125V3. The pool number column C131 manages information for identifying one or more pools 122 that the storage apparatus 10 is able to use. In FIG. 27, only one pool 122 is shown, but the storage apparatus 10 may also comprise multiple pools 122.

The in-pool page number column C132 manages information for identifying the real pages 125R1 through 125R3 that are stored in the pool 122. At least one or more, and normally multiple real volumes 12(2) through 12(4) are registered in the pool 122.

The destruction flag column C133, for example, manages destruction flags, which denote whether or not a page is capable of being destroyed in a case where an unused page results from the defragmentation process. A page for which “Yes” is set in the destruction flag column C133 can be destroyed. A page for which “No” is set in the destruction flag column C133 cannot be destroyed.

Whether or not it is possible to destroy the respective virtual pages of the virtual volume 124 can be learned in accordance with information D20 from the “OS or file system” P21 of the server 20 (hereinafter, the file system and so forth P21). The information D20, for example, comprises the page usage in accordance with the file system and so forth P21 (for example, identification information for identifying a page that is not being used).

The configuration may be such that the storage apparatus 10 detects whether or not a real page is capable of being destroyed. The storage system 10 may be configured so as to analyze the data of a real page allocated to a virtual page and determine whether or not this real page is being used.

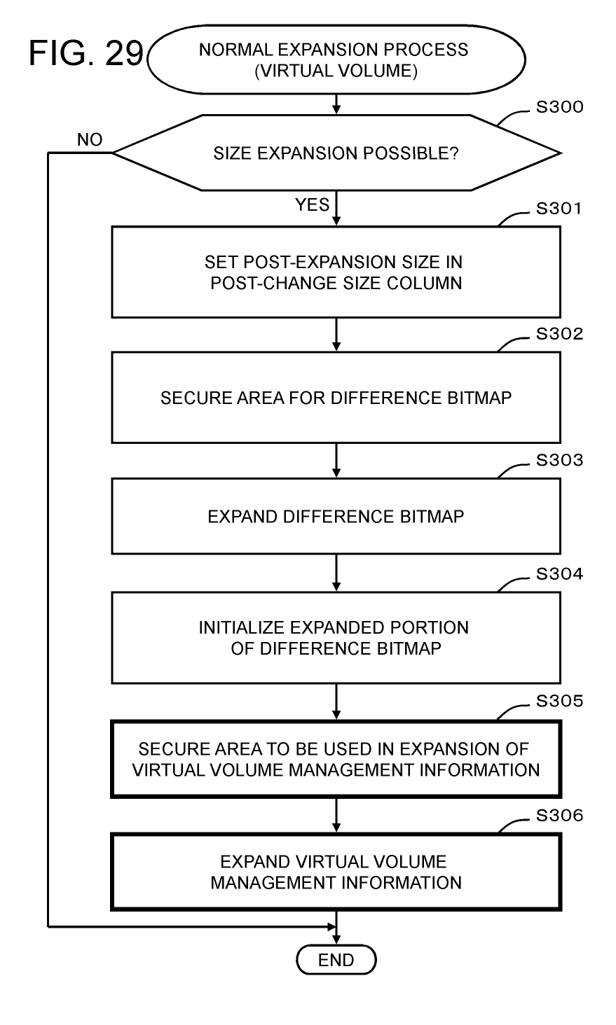

FIG. 29 is a flowchart of a normal expansion process that is used for expanding the size of the virtual volume 124. Since S300 through 5304 of the flowchart shown in FIG. 29 correspond to S50 through S54 of the flowchart shown in FIG. 13, explanations thereof will be omitted.

After expanding the size of the difference bitmap T12 related to the virtual volume 124 (S303, S304), the storage apparatus 10 secures from the memory 111 a free area for expanding the virtual volume management information T13 (S305). The storage apparatus 10 expands the virtual volume management information T13 by connecting the secured free area to the virtual volume management information T13 (S306).

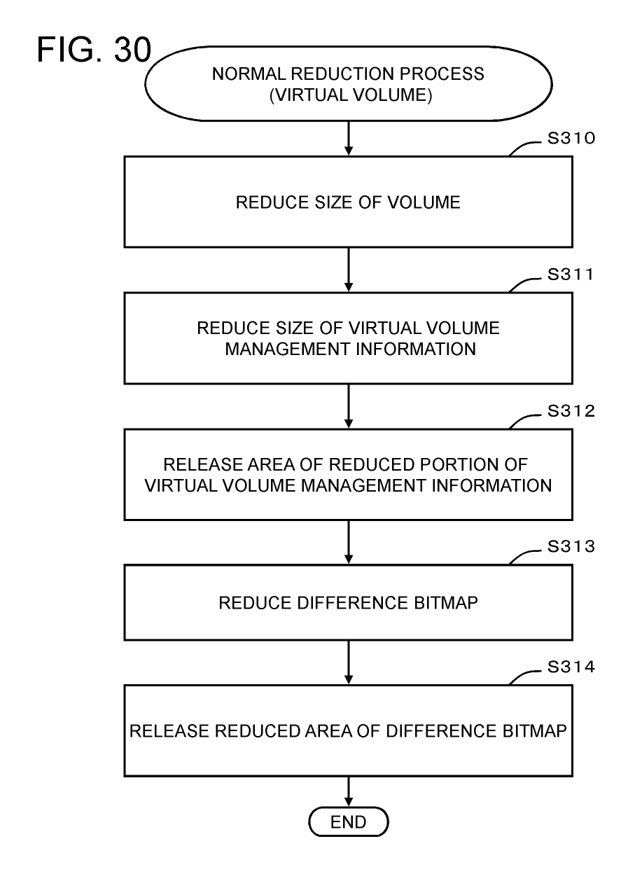

FIG. 30 is a flowchart of a normal reduction process that is used for reducing the size of the virtual volume 124.

The storage apparatus 10 determines whether or not it is possible to reduce the size of the virtual volume that is targeted for size reduction, and in a case where it is determined that reduction is possible, sets the post-reduction size in the value of the size column C101 for the virtual volume (S310).

The storage apparatus 10 disconnects the memory area that had been allocated to the virtual volume management information T13, reduces the size of the virtual volume management information T13 (S311), and releases the disconnected memory area by restoring same to the unused state (S312).

In addition, the storage apparatus 10 disconnects a portion of the memory area from the difference bitmap T12 to reduce the size of the difference bitmap T12 (S314). The storage apparatus 10 changes the status of the disconnected memory area to the unused state, and releases this memory area (S314).

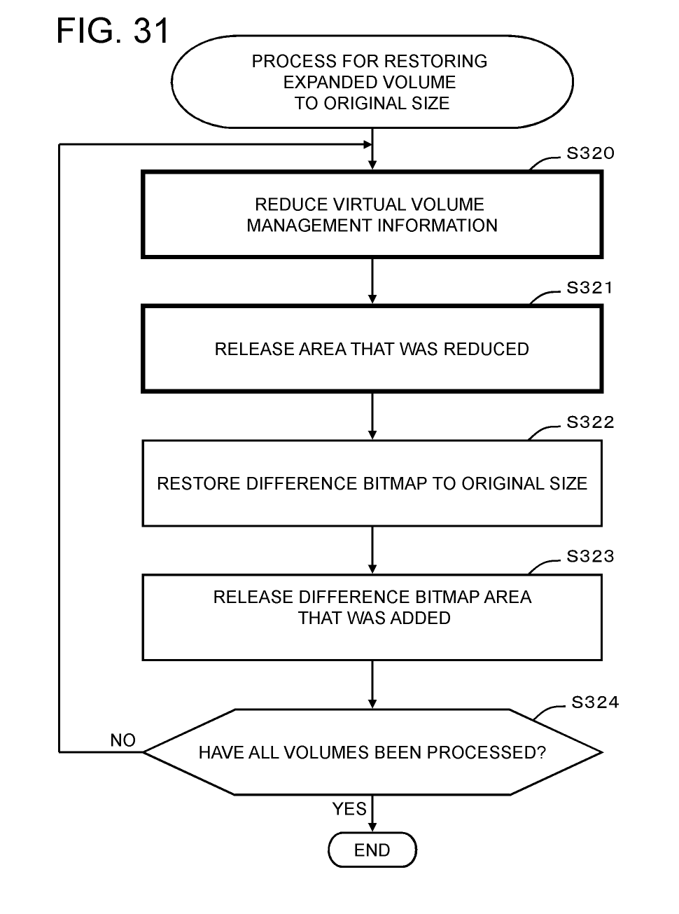

FIG. 31 is a flowchart showing a process for restoring an expansion to its original size. The storage apparatus 10 disconnects the memory area connected to the virtual volume management information T13, restores the virtual volume management information T13 to its original size (S320), and releases this disconnected memory area by restoring same to the unused state (S321).

The storage apparatus 10 disconnects, from the difference bitmap T12, the memory area that was added to the difference bitmap T12 to restore the difference bitmap T12 to its original size (S322). The storage apparatus 10 releases the disconnected memory area and restores same to the unused state (S323).

The storage apparatus 10 determines whether or not the restore-to-original process has been executed for all the logical volumes that were expanded (S324). The storage apparatus 10 confirms that the value of the size column C101 and the value of the post-change size column C106 are identical for all the volumes comprising the copy pair.

In a case where all the volumes related to the copy pair have been restored to their original sizes (S324: YES), the storage apparatus 10 ends this processing. In a case where there is a volume that has not been restored to pre-expansion size status, the processing returns to S320.

Configuring this embodiment like this also achieves the same effect as the first embodiment. In addition, in this embodiment, the size of a Thin Provisioning volume comprising the copy pair can also be changed while maintaining this copy pair as-is.

### Embodiment 3

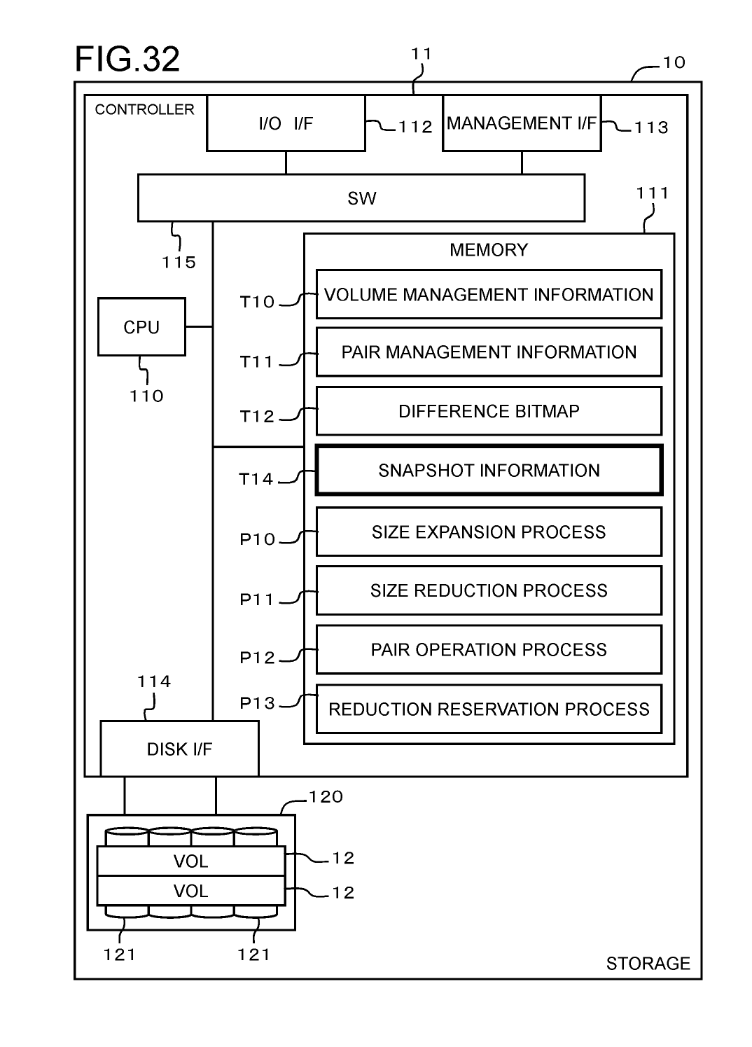

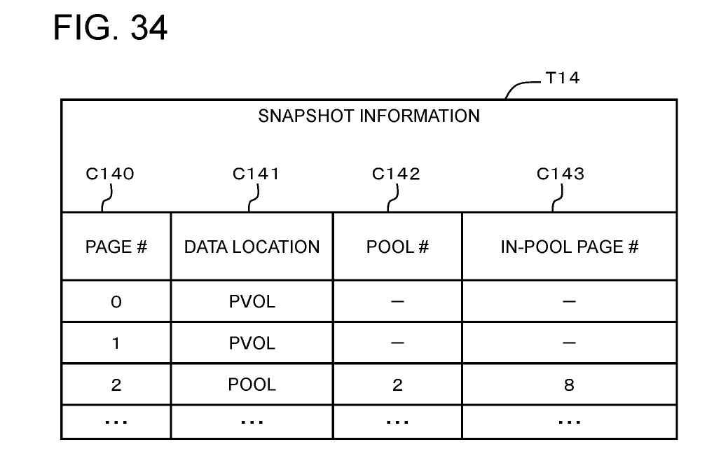

A third embodiment will be explained by referring to FIGS. 32 through 38. In this embodiment, a case that applies to changing the size of a snapshot volume will be explained. FIG. 32 shows the configuration of a storage apparatus 10 according to this embodiment. The memory 111 stores snapshot information T14. The snapshot information T14 will be explained in detail using FIG. 34.

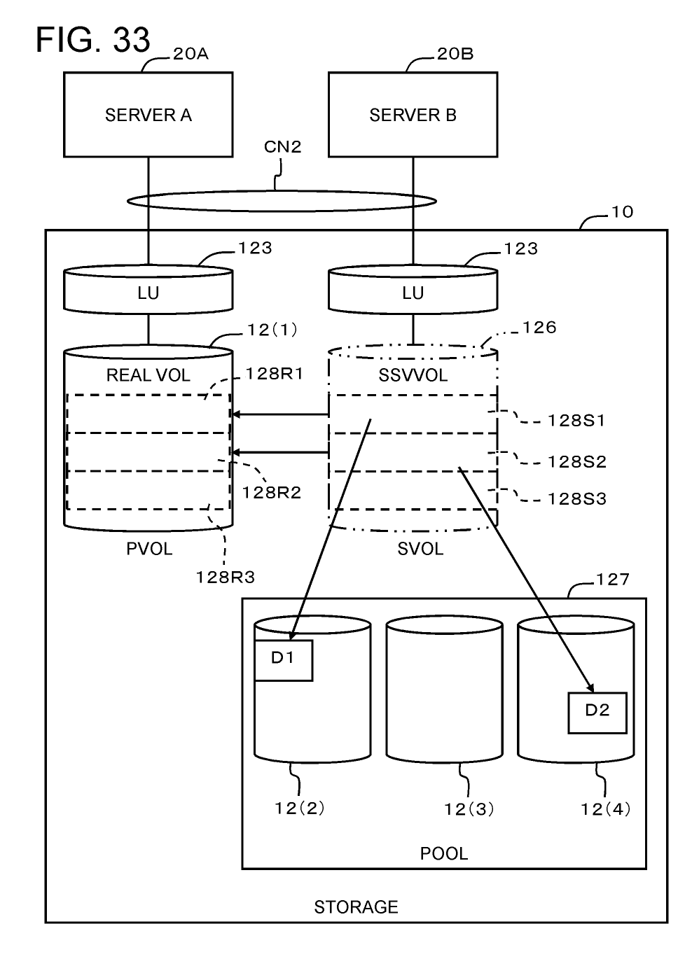

FIG. 33 schematically shows the configuration of a snapshot volume 126. The snapshot volume 126 is a volume that is created virtually, and is associated with a real volume 12(1), which is a copy source. Data is either stored in the real volume 12(1) or in any of real volumes 12(2) through 12(4) inside a snapshot pool 127.

At the point in time at which the real volume 12(1), which is the copy source, is separated from the snapshot volume 126, which is the copy destination, respective storage areas 128S1 through 128S3 of the snapshot volume 126 are associated with storage areas 128R1 through 128R3 of the real volume 12(1).

When the server 20 accesses either the snapshot volume 126 or the real volume 12(1), the access-target data D1, D2 is saved inside the snapshot pool 127.

Of the storage areas of the snapshot volume 126, areas 128S1 and 128S2, where the data D1, D2 were saved in the pool 127, are associated with the storage area inside the pool 127. That is, the mapping destination of the snapshot volume 126 is changed from the real volume 12(1) to a storage area (real page) inside the pool.

FIG. 34 shows an example of the snapshot information T14. The snapshot information T14, for example, comprises a page number column C140, a data location column C141, a pool number column C142, and an in-pool page number column C143.

The page number column C140 manages information for identifying the respective pages 128S1 through 128S3 inside the snapshot volume 126. The data location column C141 manages information denoting the storage destinations of the data in the snapshot volume 126. “PVOL” is set in a case where the data is stored in the real volume 12(1), which is the copy source, and “pool” is set in a case where the data is stored inside the pool 127.

The pool number column C142 manages information for identifying at least one pool 127 that the storage apparatus 10 is able to use. The in-pool page number column C143 manages information for identifying a real page inside the pool 127.

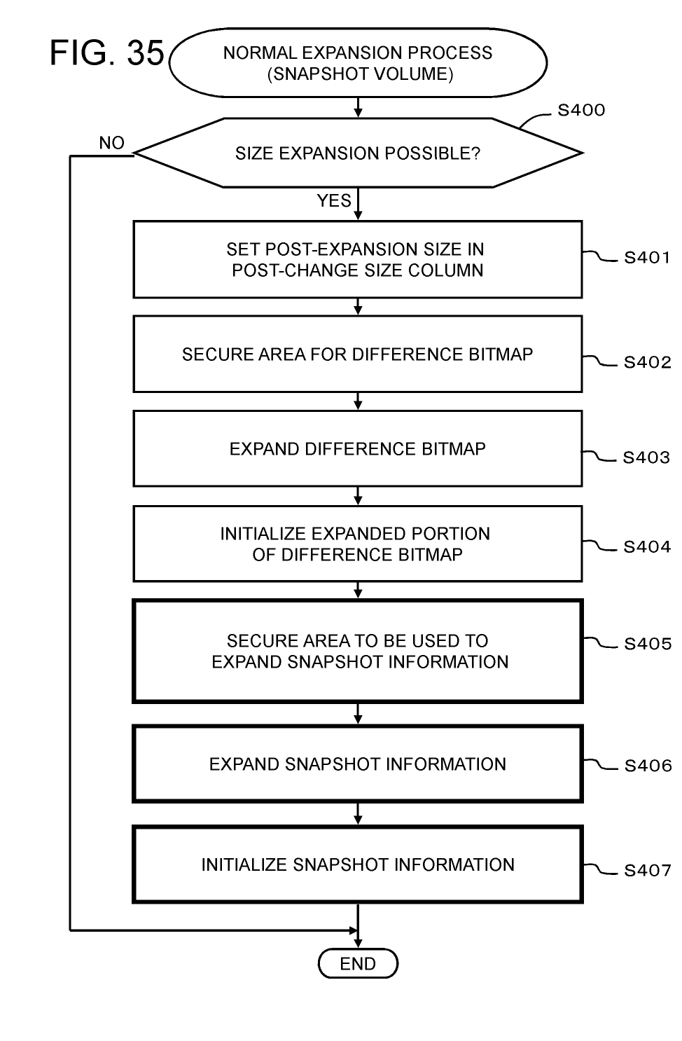

FIG. 35 is a flowchart of a normal expansion process that is used for expanding the size of the snapshot volume 126. Since S400 through 5404 of the flowchart shown in FIG. 35 correspond to S50 through S54 of the flowchart shown in FIG. 13, explanations thereof will be omitted.

The storage apparatus 10 expands the size of the difference bitmap T12 related to the virtual volume 124 (S403, S404), and thereafter secures from the memory 111 a free area for expanding the snapshot information T14 (S405).

The storage apparatus 10 expands the snapshot information T14 by connecting the secured memory area to the snapshot information T14 (S406). The storage apparatus 10 initializes the snapshot information T14 (S407). The initialization of the snapshot information T14 sets the values of the data location column C141 such that the storage destinations of all the expanded pages show PVOL.

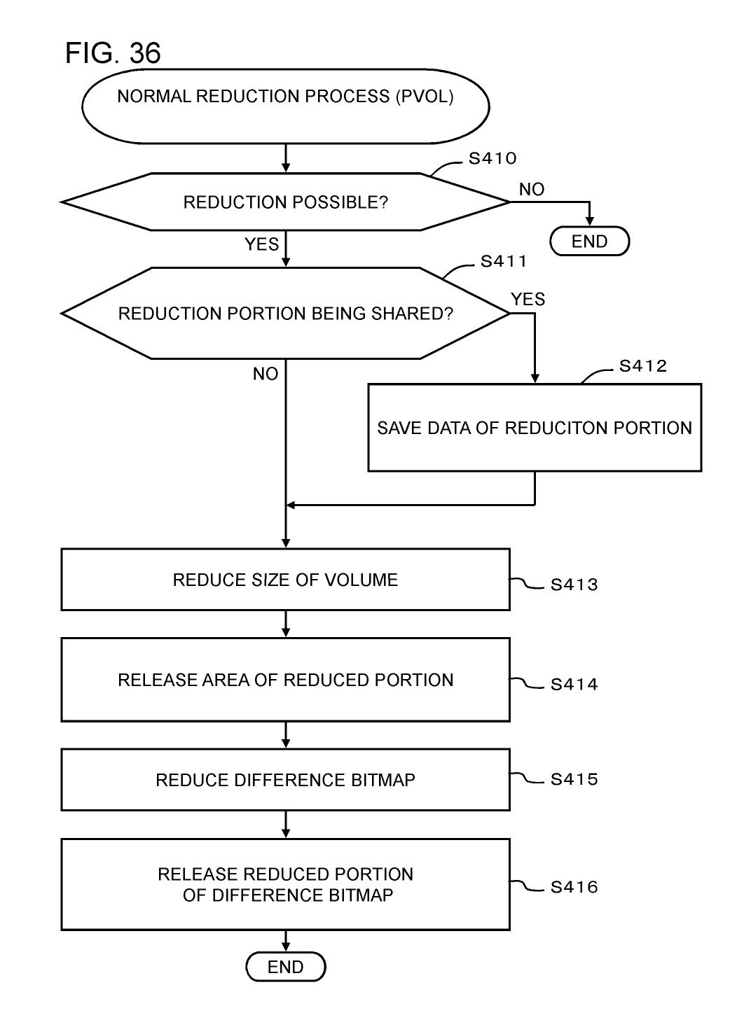

FIG. 36 is used for reducing the size of the real volume 12(1) that forms a pair with the snapshot volume 126.

The storage apparatus 10 determines whether or not it is possible to reduce the size of the real volume, which is the copy source (S410). When the size of the real volume cannot be reduced as in a case where data is stored in the reduction-target area (S410: NO), this processing ends.

In a case where it is possible to reduce the size of the real volume (S410: YES), a determination is made as to whether data stored in the reduction-target area (reduction-target real page) is being shared with the snapshot volume 126 (S411).

In a case where the data of the reduction-target page is being shared (S411: YES), the storage apparatus 10 saves this shared data to a real page inside the snapshot pool 127 (S412). The snapshot volume 126 that is sharing this data changes the mapping destination of the area 128S corresponding to this data to the save-destination page inside the pool 127.

In a case where either the data of the reduction-target page is not being shared (S411: NO) or the shared data save has ended, the storage apparatus 10 disconnects a portion of the storage area from the real volume to reduce the size of this real volume (S413). The disconnected storage area is released as an unused area (S414).

In addition, the storage apparatus 10 reduces the size of the difference bitmap T12(S415), and releases the memory area that was disconnected from the difference bitmap T12 by returning same to the unused state (S416).

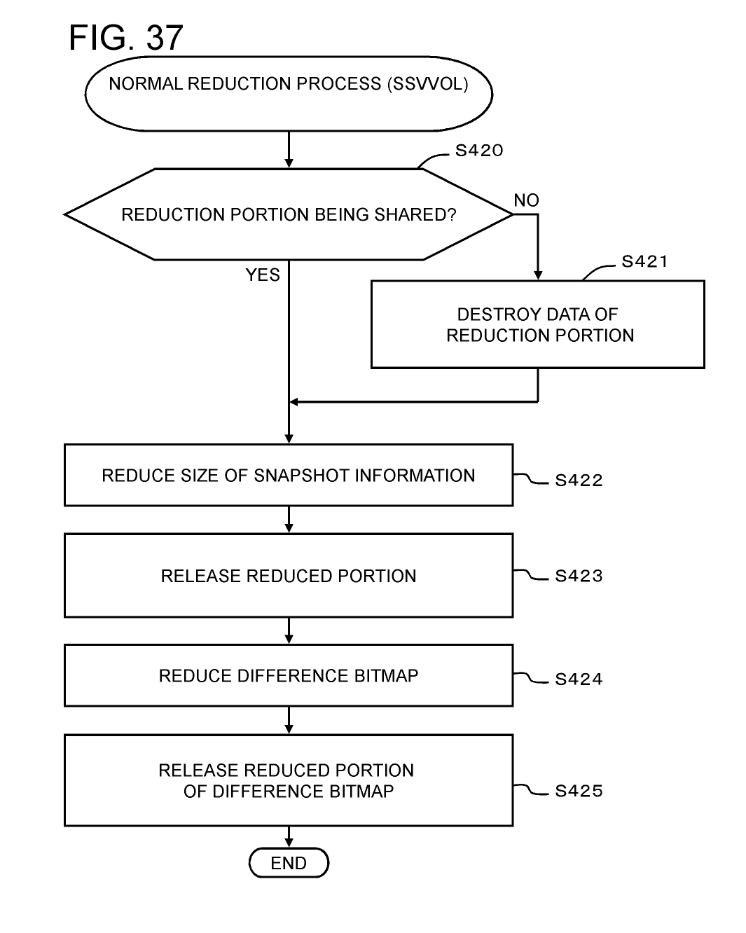

FIG. 37 is a flowchart showing a normal reduction process that is used to reduce the size of the snapshot volume 126.

The storage apparatus 10 determines whether or not the data stored in the reduction-target area of the snapshot volume 126 is being shared with another volume (S420). In a case where the data stored in the reduction-target area is not being shared (S420: NO), the storage apparatus 10 destroys this data (S421).

In a case where either the data stored in the reduction-target area is being shared (S420: YES) or unshared data has been destroyed (S421), the storage apparatus 10 reduces the size of the snapshot information T14 (S422), and releases the memory area that was disconnected from the snapshot information T14 (S423).

The storage apparatus 10 also reduces the size of the difference bitmap T12 (S424), and releases the memory area that was disconnected from the difference bitmap T12 as well (S425).

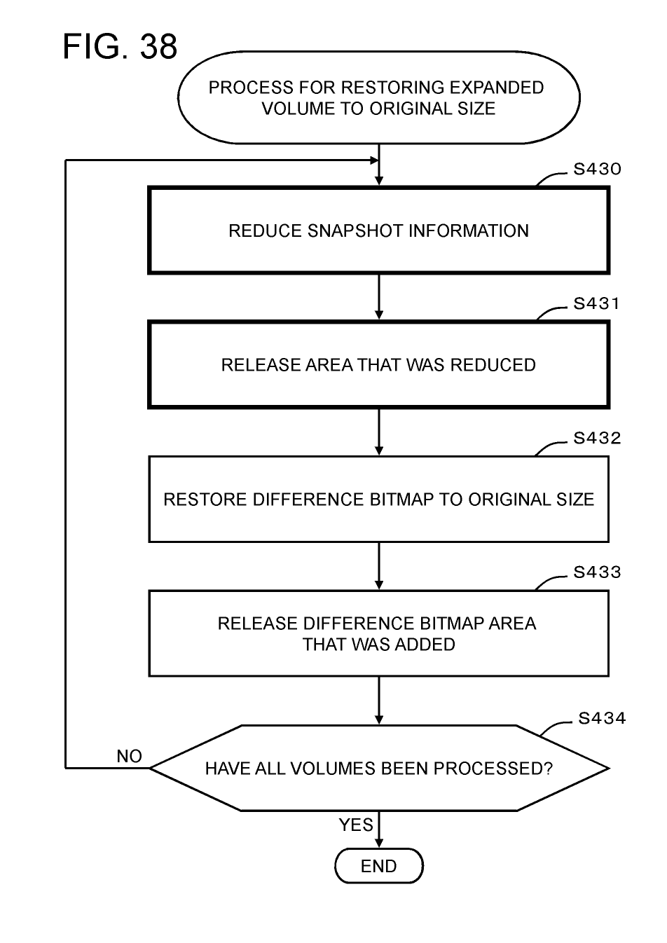

FIG. 38 is a flowchart showing a process for restoring an expansion to its original size. The storage apparatus 10 disconnects a memory area connected to the snapshot management information T14, restores the snapshot information T14 to its original size (S430), and releases this disconnected memory area by returning same to the unused state (S431).

Similarly, the storage apparatus 10 disconnects the memory area that was added to the difference bitmap T12 from the difference bitmap T12, and restores the size of the difference bitmap T12 to its original value (S432). The storage apparatus 10 releases the disconnected memory area and returns same to the unused state (S433). The storage apparatus 10 determines whether or not the restore-to-original process was executed for all of the logical volumes that had been expanded (S434).

This embodiment also achieves the same effects as the first and second embodiments.

### Embodiment 4

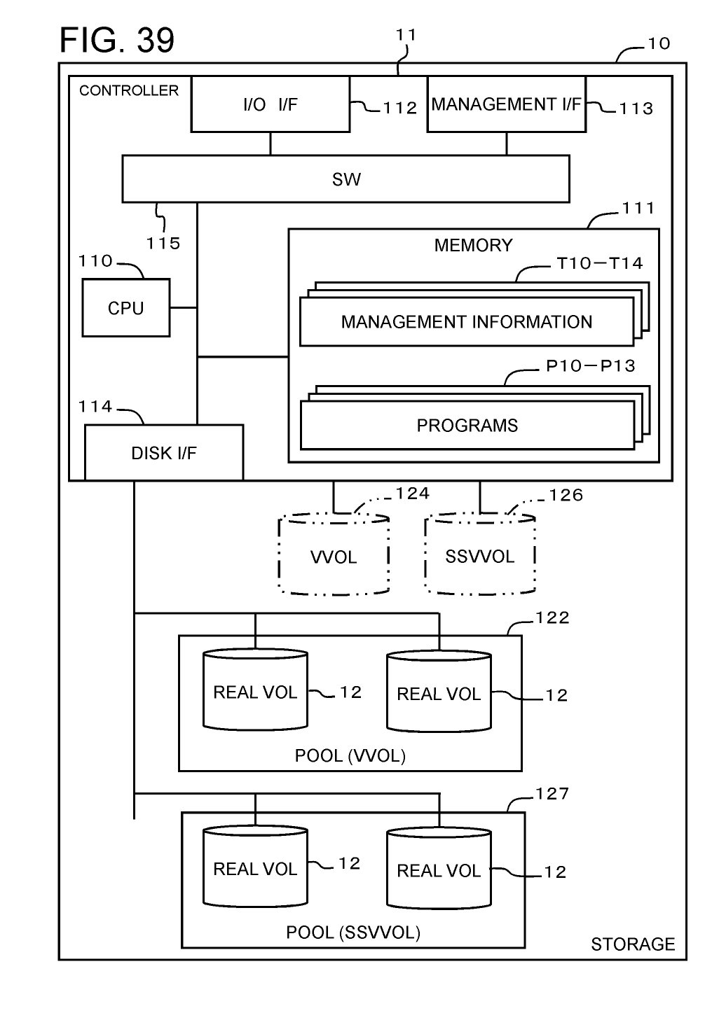

FIG. 39 shows the configuration of a storage apparatus related to a fourth embodiment. This embodiment joins together the configuration of the second and third embodiments. As shown in FIG. 39, the respective sizes of the Thin Provisioning volume 124 and the snapshot volume 126 can be changed appropriately on the basis of the copy pair status and the volume type.

Furthermore, the present invention is not limited to the embodiments described hereinabove. A person with ordinary skill in the art will be able to make various additions and changes without departing from the scope of the present invention.

### REFERENCE SIGNS LIST

10, 10A, 10B Storage apparatus (Storage control apparatus)
20, 20A, 20B Server (Host computer)
30 Management server

1. A storage control apparatus, which inputs and outputs data based on a command from a host computer, the storage control apparatus comprising:
multiple logical volumes that are used by the host computer; and
a controller for controlling the respective logical volumes,
wherein the controller comprises:
a microprocessor; and
a memory for storing a prescribed computer program that is executed by the microprocessor, and
wherein by reading from the memory and executing the prescribed computer program,
upon receiving an instruction to change a size of a prescribed logical volume selected from among the multiple logical volumes, the microprocessor:
decides on, based on a copy pair status related to the prescribed logical volume, one or more logical volumes including at least the prescribed logical volume from among the multiple logical volumes, as a change-target volume to be a size change target,
decides on a prescribed time for changing the size of the decided change-target logical volume, and
changes the size of the decided change-target logical volume to a prescribed value specified in the change instruction at the decided prescribed time.

2. A storage control apparatus according to claim 1, wherein the microprocessor decides on a primary volume and a secondary volume related to the copy pair as the change-target logical volumes in a case where the copy pair statuses are pair and resynch,
decides on only the primary volume related to the copy pair as the change-target logical volume in a case where the copy pair status is suspend, and
decides on the primary volume and the secondary volume related to the copy pair as the change-target logical volumes in a case where the copy pair status is restore.

3. A storage control apparatus according to claim 2, wherein in a case where multiple change-target logical volumes have been decided, the microprocessor decides on the prescribed time by taking into account a direction in which data is sent between the change-target logical volumes,
the prescribed time comprises:
a first time for changing the size of a logical volume, of the change-target logical volumes, which constitutes a data source; and
a second time for changing the size of a logical volume, of the change-target logical volumes, which constitutes a data destination, and
the first time and the second time differ from each other.

4. A storage control apparatus according to claim 3, wherein in a case where multiple change-target logical volumes have been decided, the microprocessor decides on the prescribed time by taking into account whether the change instruction denotes a size expansion or a size reduction, and the direction in which data is sent.

5. A storage control apparatus according to claim 4, wherein in a case where the change instruction denotes a size expansion, the microprocessor first expands the size of the data-destination logical volume of the change-target logical volumes, and subsequently expands the size of the data-source logical volume of the change-target logical volumes, and
in a case where the change instruction denotes a size reduction, first reduces the size of the data-source logical volume of the change-target logical volumes, and subsequently reduces the size of the data-destination logical volume of the change-target logical volumes.

6. A storage control apparatus according to claim 5, wherein in a case where there exists prescribed management information related to the change-target logical volume, the microprocessor changes the size of a management information storage area for storing the prescribed management information in accordance with the size change of the change-target logical volume.

7. A storage control apparatus according to claim 6, wherein the prescribed management information comprises at least one of difference data management information for managing difference data that occurs with respect to the copy pair; and correspondence management information for correspondingly managing, in a case where the change-target logical volume is a virtual volume that is created virtually, a virtual storage area inside the virtual volume and a real storage area inside a pool.

8. A storage control apparatus according to claim 7, wherein the microprocessor synchronizes the prescribed time with a time for the host computer to re-recognize the size of the change-target logical volume.

9. A storage control apparatus according to claim 8, wherein, in a case where the size of the change-target logical volume is to be reduced, the microprocessor first reduces a recognition size to be recognized by the host computer to the prescribed value,
the host computer then recognizes the size of the change-target logical volume based on the recognition size, and
the microprocessor lastly reduces the size of the change-target logical volume to the prescribed value based on the change instruction.

10. A storage control apparatus according to claim 9, wherein, in a case where the size of the change-target logical volume is to be expanded, the microprocessor first expands the size of the change-target logical volume, and
the host computer then recognizes the size of the change-target logical volume.

11. A storage control apparatus according to claim 10, wherein in a case where the microprocessor changes a copy pair status to either restore or resynch, the microprocessor determines whether or not the sizes of the respective logical volumes configuring the copy pair are identical, and in a case where it is determined that these sizes are not identical, changes the copy pair status to either restore or resynch after making the sizes of the respective logical volumes identical.

12. A storage control apparatus according to claim 11, wherein the microprocessor makes the size of the data-destination logical volume of the logical volumes configuring the copy pair, identical to the size of the data-source logical volume of the logical volumes.

13. A storage control apparatus according to claim 12, wherein the microprocessor acquires, from the host computer, information related to a reducible area of a storage area of the change-target logical volume.

14. A method for setting sizes of logical volumes configuring a copy pair, comprising the steps of:
receiving a change instruction from a management apparatus;
acquiring a copy pair status related to a prescribed logical volume specified by the change instruction;
deciding on one or more logical volumes including at least the prescribed logical volume from among multiple logical volumes, as a change-target volume to be a size change target;
deciding on a prescribed time for changing the size of the decided change-target logical volume; and
changing the size of the decided change-target logical volume to a prescribed value specified in the change instruction at the decided prescribed time.

15. A method for setting sizes according to claim 14, further comprising:
deciding on a primary volume and a secondary volume related to the copy pair as the change-target logical volumes in a case where the copy pair statuses are pair and resynch,
deciding on only the primary volume related to the copy pair as the change-target logical volume in a case where the copy pair status is suspend, and
deciding on the primary volume and the secondary volume related to the copy pair as the change-target logical volumes in a case where the copy pair status is restore.

16. A method for setting sizes according to claim 15, wherein in a case where multiple change-target logical volumes have been decided, a microprocessor decides on the prescribed time by taking into account a direction in which data is sent between the change-target logical volumes,
the prescribed time comprises:
a first time for changing the size of a logical volume, of the change-target logical volumes, which constitutes a data source; and
a second time for changing the size of a logical volume, of the change-target logical volumes, which constitutes a data destination, and
the first time and the second time differ from each other.

17. A method for setting sizes according to claim 16, wherein in a case where multiple change-target logical volumes have been decided, the microprocessor decides on the prescribed time by taking into account whether the change instruction denotes a size expansion or a size reduction, and the direction in which data is sent.

18. A method for setting sizes according to claim 17, wherein in a case where the change instruction denotes a size expansion,
the microprocessor first expands the size of the data-destination logical volume of the change-target logical volumes, and subsequently expands the size of the data-source logical volume of the change-target logical volumes, and
in a case where the change instruction denotes a size reduction,
the microprocessor first reduces the size of the data-source logical volume of the change-target logical volumes, and subsequently reduces the size of the data-destination logical volume of the change-target logical volumes.

19. A method for setting sizes according to claim 18, wherein in a case where there exists prescribed management information related to the change-target logical volume,
the microprocessor changes the size of a management information storage area for storing the prescribed management information in accordance with the size change of the change-target logical volume.

20. A method for setting sizes according to claim 19, wherein the prescribed management information comprises at least one of: difference data management information for managing difference data that occurs with respect to the copy pair; and correspondence management information for correspondingly managing, in a case where the change-target logical volume is a virtual volume that is created virtually, a virtual storage area inside the virtual volume and a real storage area inside a pool.

21. A method for setting sizes according to claim 20, wherein the microprocessor synchronizes the prescribed time with a time for the host computer to re-recognize the size of the change-target logical volume.

22. A method for setting sizes according to claim 20, wherein, in a case where the size of the change-target logical volume is to be reduced, the microprocessor first reduces a recognition size to be recognized by the host computer to the prescribed value,
the host computer then recognizes the size of the change-target logical volume based on the recognition size, and
the microprocessor lastly reduces the size of the change-target logical volume to the prescribed value based on the change instruction.

23. A method for setting sizes according to claim 20, wherein, in a case where the size of the change-target logical volume is to be expanded, the microprocessor first expands the size of the change-target logical volume, and
the host computer then recognizes the size of the change-target logical volume.

24. A method for setting sizes according to claim 23, wherein in a case where the microprocessor changes a copy pair status to either restore or resynch,
the microprocessor determines whether or not the sizes of the respective logical volumes configuring the copy pair are identical, and in a case where it is determined that these sizes are not identical,
the microprocessor changes the copy pair status to either restore or resynch after making the sizes of the respective logical volumes identical.

25. A method for setting sizes according to claim 24, wherein the microprocessor makes the size of the data-destination logical volume of the logical volumes configuring the copy pair, identical to the size of the data-source logical volume of the logical volumes.

26. A method for setting sizes according to claim 25, wherein the microprocessor acquires, from the host computer, information related to a reducible area of a storage area of the change-target logical volume.
